(19) United States
(12) Patent Application Publication
(10) Pub. No.: US 2018/0321648 A1
(43) Pub. Date: Nov. 8, 2018

(54) SUPPLY AND DEMAND ADJUSTING DEVICE, SUPPLY AND DEMAND ADJUSTING SYSTEM, AND ENERGY SUPPLY AND DEMAND ADJUSTING METHOD

(71) Applicant: Mitsubishi Electric Corporation, Chiyoda-ku (JP)

(72) Inventors: Shinya MAKINO, Tokyo (JP); Mitsuru TSUCHIDA, Tokyo (JP)

(73) Assignee: Mitsubishi Electric Corporation, Chiyoda-ku (JP)

(21) Appl. No.: 15/772,840

(22) PCT Filed: Dec. 1, 2016
(86) PCT No.: PCT/JP2016/085691

§ 371 Date: May 2, 2018

(30) Foreign Application Priority Data
Dec. 14, 2015 (JP) 2015-242905

(51) Int. Cl. G05B 19/042

(52) U.S. Cl. CPC G05B 19/042; G05B 2219/2639

(57) ABSTRACT

A supply and demand adjusting device: sets a requested reduction amount of energy at date and time when energy usage is scheduled to be reduced to be larger than a target value, and notifies a supply and demand mediating device of the requested reduction amount and the scheduled date and time together; receives a total amount of reducible energy reducible by the consumer from the supply and demand mediating device as a reply to the notification; as the scheduled date and time approaches, inquires of the supply and demand mediating device about a total amount of reducible energy reducible by the consumer at the time of the inquiry; decreases the requested reduction amount stepwise so as to make the requested reduction amount approach the target value; and each time the requested reduction amount is decreased notifies the supply and demand mediating device of the resultant requested reduction amount.

### TECHNICAL FIELD

The present invention relates to a supply and demand adjusting device, a supply and demand adjusting system, and an energy supply and demand adjusting method.

### BACKGROUND ART

A known supply and demand adjusting system is such that a utility company and an aggregator change an incentive to a consumer through an information network to adjust supply and demand dynamically. The utility company mentioned herein means a company that manufactures and feeds energy.

The aggregator mentioned herein means a business operator that collects demands of multiple consumers and controls a demanded amount, thereby acting as an intermediary to provide more effective service of a supply and demand system.

In response to growing interest in energy in recent years, request for restricting energy demand at its peak is increasing. For adjustment of energy demand, a supply side (utility company) requests a demand side (consumer) to reduce energy usage during a peak period of time. A compensation (hereinafter also called an incentive) is paid to a consumer having responded to the request for reduction.

A technique of restricting energy demand when energy consumption is at its peak employs known systems, a price-based system and an incentive-based system. The price-based system includes an hourly price system, an emergency peak charging system, and a real-time price system. The hourly price system is a system of setting high price for time zones when energy demand is at its peak. The emergency peak charging system is a system of charging higher price during an emergency resulting from stringency of energy supply and demand than normally-charged price. The real-time price system is a system of changing a price moment by moment in response to a supply and demand balance. The incentive-based system is a system of paying a compensation for energy reduction to a consumer. The present invention belongs to the incentive-based technique.

A supply and demand adjusting system employing the incentive-based technique is expected to achieve energy reduction targeted by a supply side with an incentive responsive to various conditions for energy reduction (such as climate, region, business condition, environment of use of power by a consumer, for example) and acceptable to both the supply side and a demand side.

For example, patent document 1 discloses a system of realizing fine supply and demand adjustment by making a supply side make bidirectional communication with a demand side through an aggregator. According to patent document 1, an incentive is changed dynamically to allow adjustment of an energy amount with an optimum incentive unit price during stringency of supply and demand.

### PRIOR ART DOCUMENTS

### Patent Documents

Patent document 1: Publication of PCT International Application No. 2013/179876

### SUMMARY

### Problem to be Solved by the Invention

In a supply and demand adjusting system, it is desirable that energy reduction targeted by a supply side be achieved with an incentive unit price acceptable to both the supply side and a demand side. It is also desirable that a proper and optimum target energy reduction amount be achieved based on supply and demand prediction made on an as-needed basis by the supply side, thereby restricting unnecessary energy reduction and redundant incentive cost. An aggregator is required to immediately respond to change in an energy amount reducible by a consumer.

However, patent document 1 described above does not give consideration to realizing an optimum energy reduction amount based on supply and demand prediction made on an as-needed basis. Further, according to patent document 1 described above, consumers are not allowed to change a planned value for an energy reduction amount until collected energy reduction amounts reach a target amount. This makes it impossible for the aggregator to immediately respond to status change in an energy reduction plan made by the consumer.

The present invention has been made to solve the above-described problems. It is an object of the present invention to provide a supply and demand adjusting device, a supply and demand adjusting system, and an energy supply and demand adjusting method capable of attaining a target energy reduction amount precisely and allowing a consumer to change a reducible energy amount.

### Means to Solve the Problem

A supply and demand adjusting device according to the present invention works cooperatively with a supply and demand mediating device to adjust energy supply and demand. The supply and demand adjusting device and the supply and demand mediating device are connected in a manner that allows bidirectional communication therebetween. The supply and demand mediating device is connected to a supply and demand mediating terminal provided to a consumer in a manner that allows bidirectional communication therebetween. The supply and demand adjusting device sets a requested reduction amount of energy at date and time when energy usage is scheduled to be reduced to be larger than a target value, and notifies the supply and demand mediating device of the requested reduction amount and the scheduled date and time together. The supply and demand adjusting device receives a total amount of reducible energy reducible by the consumer from the supply and demand mediating device as a reply to the notification. As the scheduled date and time approaches, the supply and demand adjusting device inquires of the supply and demand mediating device about a total amount of reducible energy reducible by the consumer at the time of the inquiry, receives a reply to the inquiry from the supply and demand mediating device, decreases the requested reduction amount stepwise so as to make the requested reduction amount approach the target value, notifies the supply and demand mediating device of a resultant requested reduction amount each time the requested reduction amount is decreased, and receives a reply to the notification from the supply and demand mediating device.

An energy supply and demand adjusting method according to the present invention is implemented by a supply and demand adjusting device that works cooperatively with a supply and demand mediating device to adjust energy supply and demand. The supply and demand adjusting device and the supply and demand mediating device are connected in a manner that allows bidirectional communication therebetween. The supply and demand mediating device is connected to a supply and demand mediating terminal provided to a consumer in a manner that allows bidirectional communication therebetween. The method comprises: a step (a) in which the supply and demand adjusting device sets a requested reduction amount of energy at date and time when energy usage is scheduled to be reduced to be larger than a target value, and notifies the supply and demand mediating device of the requested reduction amount and the scheduled date and time together; a step (b) in which the supply and demand adjusting device receives a total amount of reducible energy from the supply and demand mediating device as a reply to the notification in the step (a); and a step (c) executed after the step (b) and in which the supply and demand adjusting device inquires of the supply and demand mediating device about a total amount of reducible energy reducible by the consumer at the time of the inquiry as the scheduled date and time approaches, receives a reply to the inquiry from the supply and demand mediating device, decreases the requested reduction amount stepwise so as to make the requested reduction amount approach the target value, notifies the supply and demand mediating device of a resultant requested reduction amount each time the requested reduction amount is decreased, and receives a reply to the notification from the supply and demand mediating device.

### Effects of the Invention

In the supply and demand adjusting device and the energy supply and demand adjusting method according to the present invention, the supply and demand adjusting device sets a requested reduction amount of energy to be larger than a target value, and notifies the supply and demand mediating device of the requested reduction amount. Then, as scheduled date and time of execution of energy reduction approaches, the supply and demand adjusting device decreases the requested reduction amount of energy stepwise, and notifies the supply and demand mediating device of the resultant requested reduction amount. This makes it possible to reduce the likelihood of shortage of an energy reduction amount on the day of execution of energy reduction. Further, the amount of energy to be actually reduced is allowed to match the target value with a high degree of precision, so that excessive energy reduction exceeding the target value is unlikely to occur. Preventing energy reduction exceeding the target value makes it possible to cut redundant incentive cost.

In the supply and demand adjusting device and the energy supply and demand adjusting method according to the present invention, as the day of execution of energy reduction approaches, the supply and demand adjusting device decreases the requested reduction amount stepwise. Thus, a change in a reducible energy amount made by the consumer is allowable, even if this change is made during making of a reduction plan. The consumer is allowed to change a reducible energy amount even when the supply and demand adjusting device collects energy reduction. This allows the supply and demand mediating device to immediately respond to change in a reducible energy amount to be made by the consumer.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram of a supply and demand adjusting system according to a first embodiment;

FIG. 2 is a hardware configuration view of a supply and demand adjusting device according to the first embodiment;

FIG. 3 is a hardware configuration view of a supply and demand mediating device according to the first embodiment;

FIG. 4 shows an example of an information database in the supply and demand adjusting system according to the first embodiment;

FIG. 5 shows an example of an overall sequence in the supply and demand adjusting system according to the first embodiment;

FIG. 6 shows an example of the overall sequence in the supply and demand adjusting system according to the first embodiment;

FIG. 7 shows an example of a negotiation sequence in the supply and demand adjusting system according to the first embodiment;

FIG. 8 shows an example of a supply and demand adjusting sequence in the supply and demand adjusting system according to the first embodiment;

FIG. 9 shows an example of the supply and demand adjusting sequence in the supply and demand adjusting system according to the first embodiment;

FIG. 10 shows an example of an adoption notifying sequence in the supply and demand adjusting system according to the first embodiment;

FIG. 11 shows an example of the adoption notifying sequence in the supply and demand adjusting system according to the first embodiment;

FIG. 12 shows an example of a previous day execution notifying sequence in the supply and demand adjusting system according to the first embodiment;

FIG. 13 shows an example of the previous day execution notifying sequence in the supply and demand adjusting system according to the first embodiment;

FIG. 14 shows an example of a current day execution notifying sequence in the supply and demand adjusting system according to the first embodiment; and

FIG. 15 shows an example of the current day execution notifying sequence in the supply and demand adjusting system according to the first embodiment.

### DESCRIPTION OF EMBODIMENT(S)

### First Embodiment

### Configuration

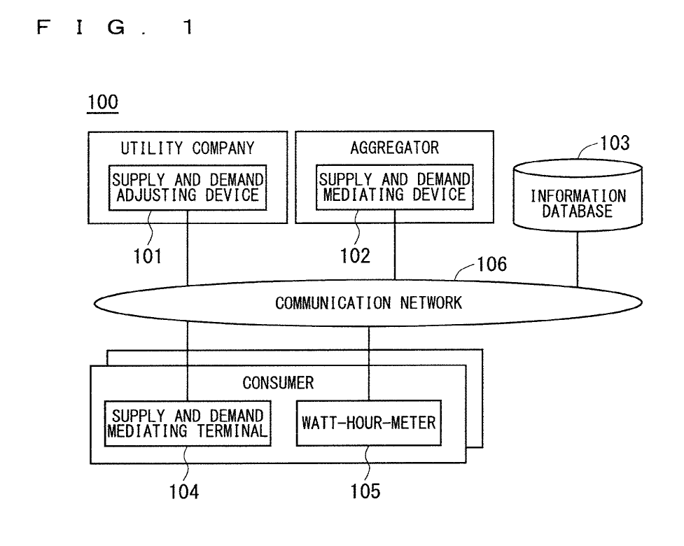

FIG. 1 is a block diagram showing the configuration of a supply and demand adjusting system 100 according to a first embodiment of the present invention. As shown in FIG. 1, the supply and demand adjusting system 100 includes a supply and demand adjusting device 101 installed on a utility company, a supply and demand mediating device 102 installed on an aggregator, an information database 103, and a supply and demand mediating terminal 104 and a watt-hour meter 105 installed on a consumer. The supply and demand adjusting device 101, the supply and demand mediating device 102, the information database 103, the supply and demand mediating terminal 104, and the watt-hour meter 105 are connected through a communication network 106 in a manner that allows bidirectional communication with each other.

A target value of an energy reduction amount at date and time when energy usage is scheduled to be reduced is set at the supply and demand adjusting device 101 held by the utility company. The supply and demand adjusting device 101 sets a requested reduction amount of energy to be larger than the target value of an energy reduction amount. Then, the supply and demand adjusting device 101 notifies the supply and demand mediating device 102 of the requested reduction amount and the scheduled date and time together. The supply and demand adjusting device 101 receives a total energy amount reducible by a consumer from the supply and demand mediating device 102 as a reply to the notification. As the scheduled date and time approaches, the supply and demand adjusting device 101 decreases the requested reduction amount stepwise so as to make the requested reduction amount approach the target value. Each time the requested reduction amount is decreased, the supply and demand adjusting device 101 notifies the supply and demand mediating device 102 of the resultant requested reduction amount. The supply and demand adjusting device 101 receives a reply to the notification from the supply and demand mediating device 102.

The supply and demand adjusting device 101 works cooperatively with the supply and demand mediating device 102 to determine a target value of an incentive (hereinafter also called an “incentive target value”) to a consumer.

The supply and demand mediating device 102 presents an incentive within a range of the incentive target value determined in cooperation with the supply and demand adjusting device 101 to the supply and demand mediating terminal 104 held by a consumer. The incentive is responsive to an energy amount reducible by the consumer (hereinafter also called a reducible energy amount). The supply and demand mediating device 102 collects the reducible energy amount from the consumer. Then, the supply and demand mediating device 102 notifies the supply and demand adjusting device 101 of a total reducible energy amount collected from each consumer.

The watt-hour meter 105 measures an energy amount consumed by a consumer. The watt-hour meter 105 may be held by any of the utility company, consumer, or aggregator.

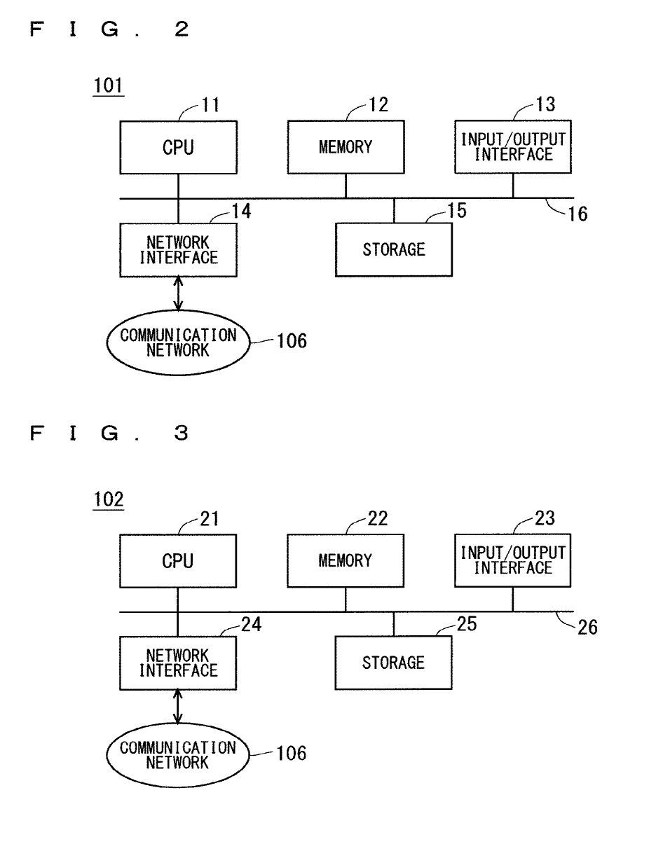

FIG. 2 is a hardware configuration view of the supply and demand adjusting device 101. The supply and demand adjusting device 101 includes a CPU 11, a memory 12, an input/output interface 13, a network interface 14, and a storage 15. These elements are mutually connected through a bus 16. The CPU 11 is a central processing unit and also called a central processor, a processing unit, an arithmetic unit, a microprocessor, a microcomputer, a processor, or a DSP.

The above-described function of the supply and demand adjusting device 101 is fulfilled by execution of a program in the memory 12 by the CPU 11. The memory 12 is a nonvolatile or volatile semiconductor memory such as a RAM, a ROM, a flash memory, an EPROM, or an EEPROM, for example. The memory 12 is also a magnetic disk, a flexible disk, an optical disk, a compact disk, a mini disc, or a DVD, for example.

The input/output interface 13 is connected to a display unit such as a display and an input unit such as a keyboard. The supply and demand adjusting device 101 is connected to the communication network 106 through the network interface 14. The storage 15 stores baseline information, a reduction registration target, etc. described later.

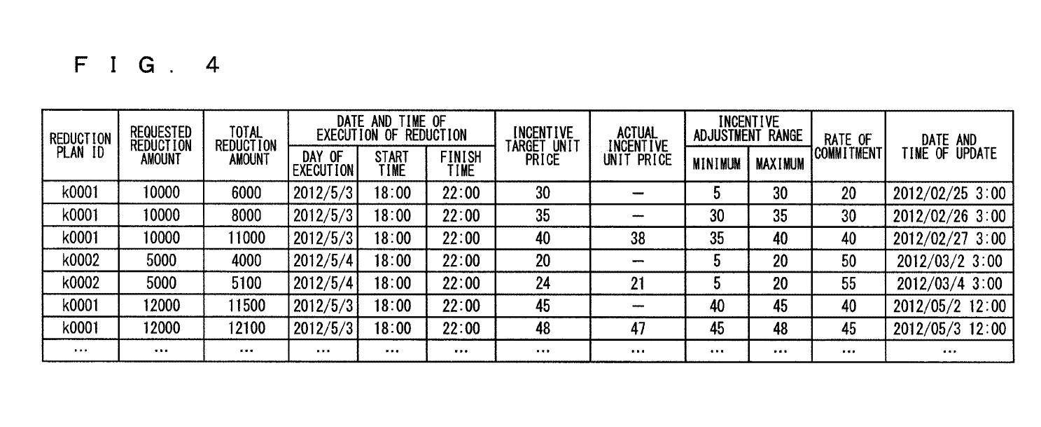

FIG. 3 is a hardware configuration view of the supply and demand mediating device 102. The supply and demand mediating device 102 includes a CPU 21, a memory 22, an input/output interface 23, a network interface 24, and a storage 25. These elements are mutually connected through a bus 26. The CPU 21 is a central processing unit and also called a central processor, a processing unit, an arithmetic unit, a microprocessor, a microcomputer, a processor, or a DSP.

The above-described function of the supply and demand mediating device 102 is fulfilled by execution of a program in the memory 22 by the CPU 21. The memory 22 is a nonvolatile or volatile semiconductor memory such as a RAM, a ROM, a flash memory, an EPROM, or an EEPROM, for example. The memory 22 is also a magnetic disk, a flexible disk, an optical disk, a compact disk, a mini disc, or a DVD, for example.

The input/output interface 23 is connected to a display unit such as a display and an input unit such as a keyboard. The supply and demand mediating device 102 is connected to the communication network 106 through the network interface 24. The storage 25 stores baseline information, a reduction registration target, etc. described later.

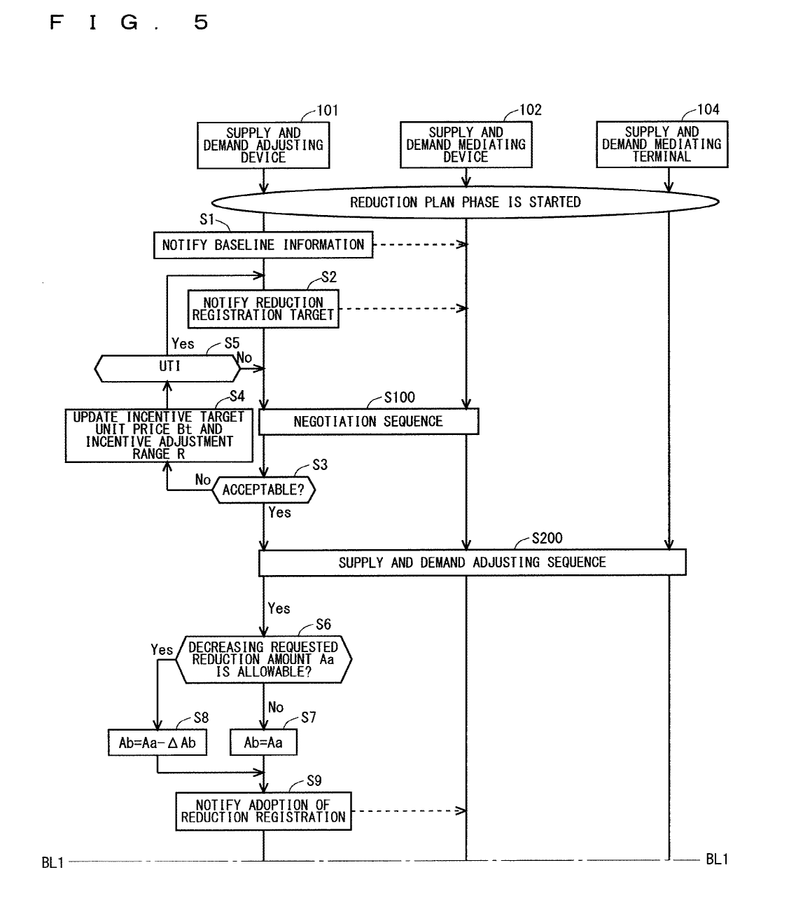

FIG. 4 shows an example of the information database 103. The information database 103 stores an energy reduction plan, contract information about a consumer and the like necessary in the supply and demand adjusting system 100. The information database 103 will be described in detail later. The information database 103 may be held by the utility company or the aggregator, or by a service provider other than the utility company and the aggregator.

### Overall Operation

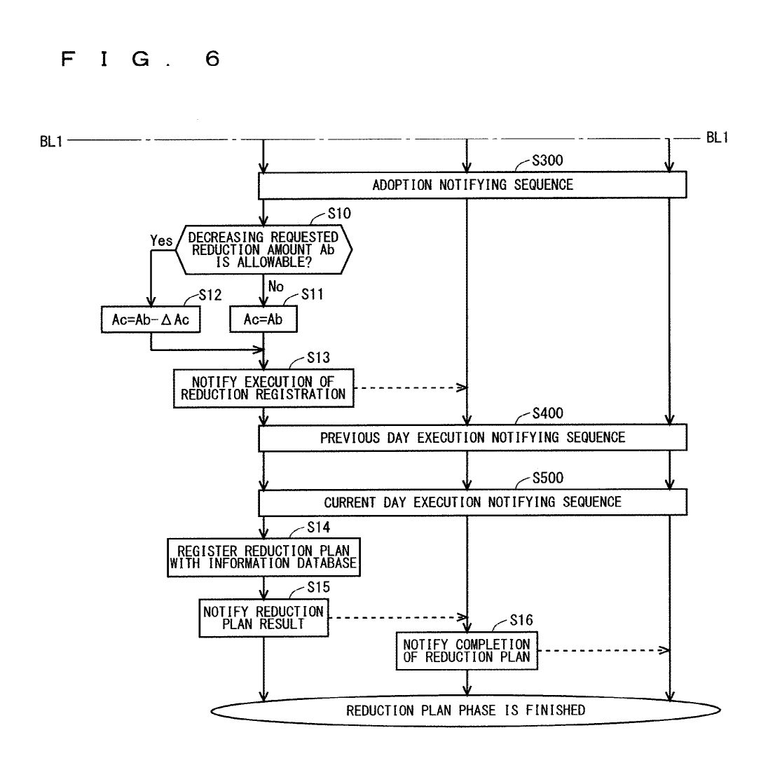

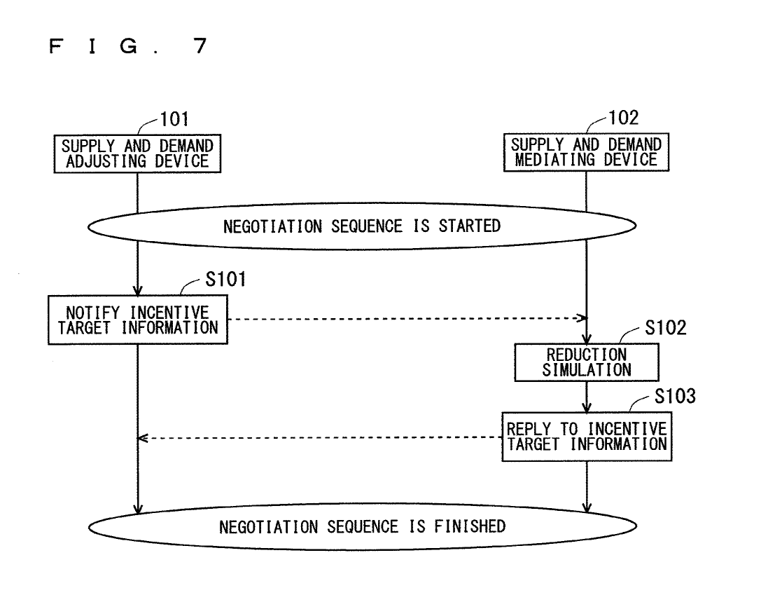

FIGS. 5 and 6 show an overall sequence in the supply and demand adjusting system 100 according to the first embodiment. FIGS. 5 and 6 are connected through a dashed part identified by BL1 to form one drawing.

The overall sequence includes the following five sequences: a negotiation sequence (step S100), a supply and demand adjusting sequence (step S200), an adoption notifying sequence (step S300), a previous day execution notifying sequence (step S400), and a current day execution notifying sequence (step S500).

The negotiation sequence is a sequence for determining a target value of energy reduction and an incentive condition. The supply and demand adjusting sequence is a sequence for collecting energy reduction until a predetermined period (Ts) has elapsed before start of execution of energy reduction. The adoption notifying sequence is a sequence for determining a consumer to receive an incentive to be paid and an energy reduction amount at a time earlier than the start of execution of energy reduction by the predetermined period (Ts), and for collecting energy reduction, if necessary. The previous day execution notifying sequence is a sequence for determining a final energy reduction amount so as to coincide with timing earlier than the start of execution of energy reduction by a predetermined period (Tg1), and for collecting energy reduction, if necessary. The current day execution notifying sequence is a sequence for determining a final energy reduction amount so as to coincide with timing earlier than the start of execution of energy reduction by a predetermined period (Tg2), and for collecting energy reduction, if necessary.

### Negotiation Sequence

When a reduction plan phase of FIG. 5 is started, the supply and demand adjusting device 101 first notifies the supply and demand mediating device 102 of baseline information (step S1). The baseline information contains energy usage about each consumer. The supply and demand adjusting device 101 notifies the supply and demand mediating device 102 of a reduction registration target (step S2). The reduction registration target contains a requested reduction amount Aa and a reduction time zone. The requested reduction amount Aa is set at a larger value than a target value so as to reduce energy reliably.

Then, the negotiation sequence (step S100) is executed between the supply and demand adjusting device 101 and the supply and demand mediating device 102. The watt-hour meter 105 installed on a consumer is managed by a utility company or an aggregator. The baseline information can be calculated based on measured information on the watt-hour meter 105. The baseline information is notified to the consumer from the utility company or aggregator.

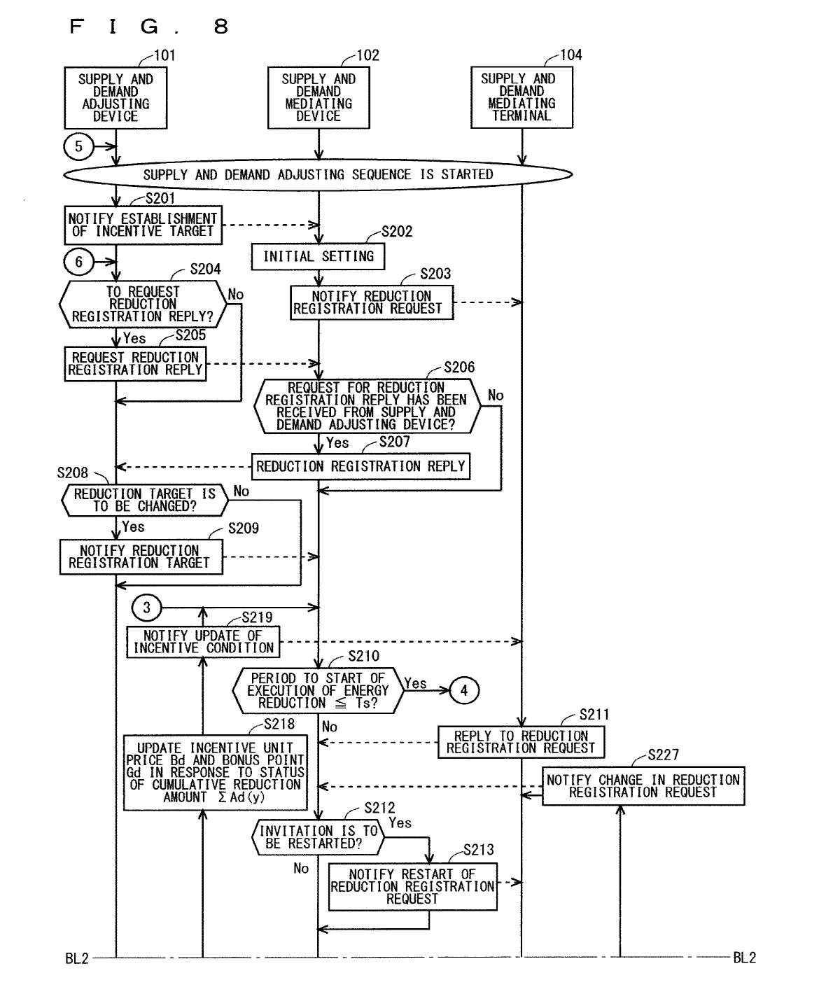

FIG. 7 shows the negotiation sequence executed between the supply and demand adjusting device 101 and the supply and demand mediating device 102. When the negotiation sequence is started between the supply and demand adjusting device 101 and the supply and demand mediating device 102, the supply and demand adjusting device 101 notifies the supply and demand mediating device 102 of incentive target information (step S101). The incentive target information contains an incentive target unit price Bt and an adjustment range R of the incentive target unit price Bt (a maximum and a minimum of the incentive target unit price).

The supply and demand mediating device 102 conducts a reduction simulation using the incentive target information notified from the supply and demand adjusting device 101 to tentatively calculate an expected reduction amount and a rate of commitment by consumers to the expected reduction amount (step S102). The rate of commitment will be described later. The reduction simulation is a simulation for predicting an energy amount reducible by each consumer. The reduction simulator is conducted based on conditions such as reduction performance in the past, climate information, the characteristics of each consumer, and an empirical rule, for example.

Then, the supply and demand mediating device 102 notifies the supply and demand adjusting device 101 of a reply to the incentive target information (step S103). The reply to the incentive target information contains the tentatively calculated expected reduction amount, a rate of commitment, and a will (Yes/No) simulated for a consumer as to whether supply and demand adjustment is to be executed. Then, the negotiation sequence is finished.

The reply from the consumer has a commitment attribute and a volunteer attribute. Commitment shows promise to attain a reduction amount (reducible energy amount). If an attribute is commitment and if the reduction amount is not attained (if an energy amount corresponding to the reducible energy amount has not been reduced successfully), a penalty is issued. If the reduction amount is attained (if an energy amount corresponding to the reducible energy amount has been reduced successfully), an incentive unit price is high. Meanwhile, if an attribute is volunteer, no penalty is issued even if the reduction amount is not attained. However, the unit price of an incentive to be paid in response to attainment is low. A rate of commitment is a rate of consumers having a commitment attribute to consumers having given reduction replies. Specifically, increase in a rate of commitment increases the probability of attaining a reduction target.

When the negotiation sequence executed between the supply and demand adjusting device 101 and the supply and demand mediating device 102 (step S100) is finished, the supply and demand adjusting device 101 determines whether to accept the expected reduction amount and the rate of commitment contained in the reply from the supply and demand mediating device 102 (step S3). If the supply and demand adjusting device 101 determines to accept the expected reduction amount and the rate of commitment, the subsequent supply and demand adjusting sequence (step S200) is executed. If the supply and demand adjusting device 101 determines not to accept the expected reduction amount and the rate of commitment, the supply and demand adjusting device 101 updates the incentive target information (step S4). Then, the supply and demand adjusting device 101 determines whether there is a need to change the reduction target (step S5). If there is no need to change the reduction target, the negotiation sequence (step S100) is executed again. If the supply and demand adjusting device 101 determines that there is a need to change the reduction target, the supply and demand adjusting device 101 notifies the supply and demand mediating device 102 of a changed reduction registration target (step S2), and then executes the negotiation sequence (step S100) again.

### Supply and Demand Adjusting Sequence

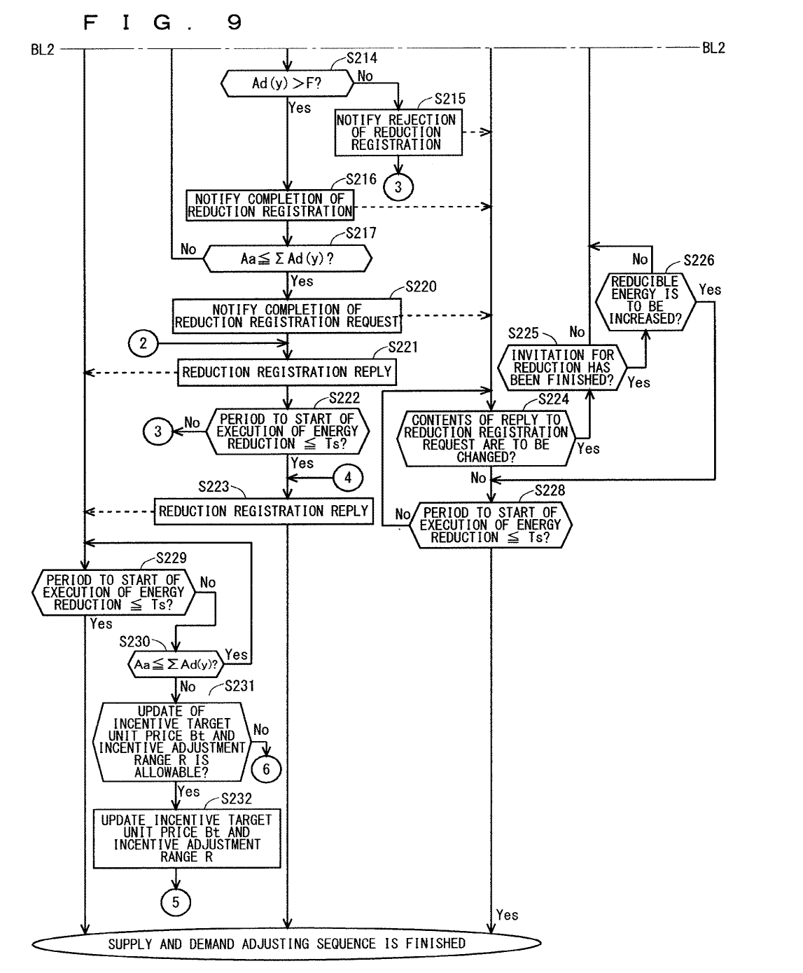

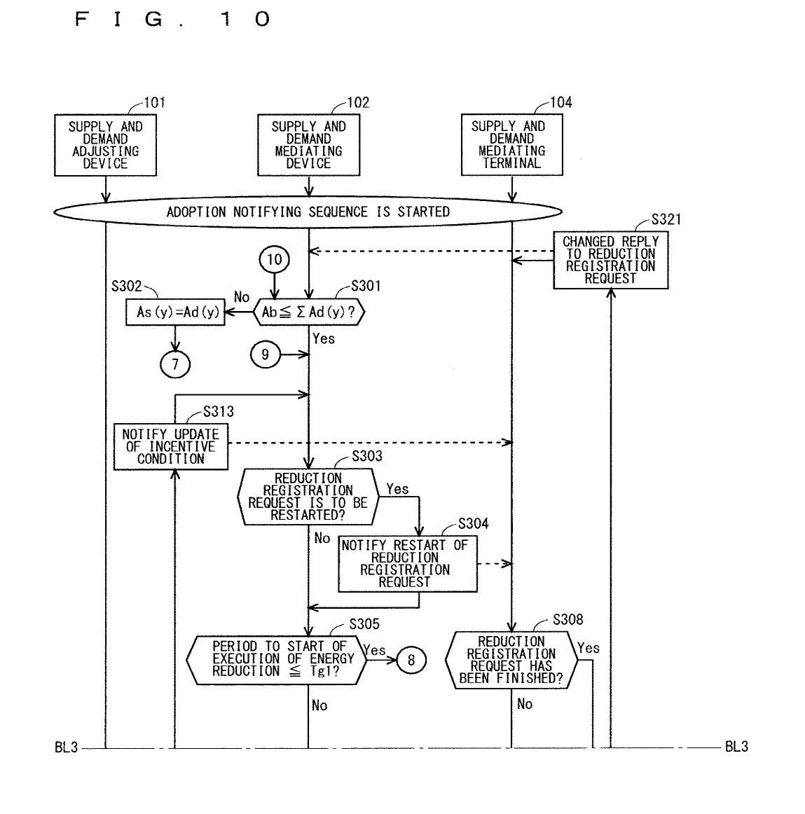

FIGS. 8 and 9 show an example of the supply and demand adjusting sequence executed between the supply and demand adjusting device 101, the supply and demand mediating device 102, and the supply and demand mediating terminal 104. FIGS. 8 and 9 are connected through a dashed part identified by BL2 to form one drawing.

When the supply and demand adjusting sequence is started, the supply and demand adjusting device 101 notifies the supply and demand mediating device 102 of the incentive target information (incentive target unit price Bt and incentive adjustment range R) (step S201) established together with the supply and demand mediating device 102 in the negotiation sequence.

In response to receipt of the notification of the incentive target information from the supply and demand adjusting device 101, the supply and demand mediating device 102 makes initial setting (step S202). During making of the initial setting, the supply and demand mediating device 102 sets a minimum reduction amount F and the incentive target unit price Bt. The minimum reduction amount F is intended to achieve efficient supply and demand adjustment by preventing the supply and demand mediating terminal 104 from making reduction registration with a reducible energy amount Ad_{(y)} of equal to or less than a certain amount.

Then, the demand mediating device 102 notifies each supply and demand mediating terminal 104 of a reduction registration request (step S203). The reduction registration request contains the requested reduction amount Aa, a reduction time zone, a processed incentive unit price Bd processed (reset) for a consumer within a range of the incentive adjustment range R, the minimum reduction amount F, and a bonus point Gd. Notification of the requested reduction amount Aa may be omitted. The bonus point Gd is a system of giving an additional incentive if a consumer makes a reduction reply at an early stage or commits a large reducible energy amount, for example, thereby putting principles of competition into operation among consumers to prompt supply and demand adjustment.

In response to receipt of the notification of the reduction registration request from the supply and demand mediating device 102, the supply and demand mediating terminal 104 makes a reply to the reduction registration request (a reply for requesting reduction registration) (step S211). The reply to the reduction registration request contains a reducible energy amount Ad_{(y)}, a reduction time zone, and an attribute (commitment or volunteer, and previous day or current day). Here, y in Ad_{(y)} is a number (y=1, 2, 3, . . . ) for identifying each supply and demand mediating terminal 104.

The above-described attribute indicating whether previous day or current day is an attribute used for selecting timing of receiving a final notification of reduction execution by a consumer from the aggregator between a previous day of energy reduction and a current day of the energy reduction. The consumer is allowed to receive a greater incentive by selecting a current day than by selecting a previous day.

The supply and demand mediating device 102 determines whether the reducible energy amount Ad_{(y)} in the reply to the reduction registration request exceeds F (step S214). If the reducible energy amount Ad_{(y)} exceeds F, the supply and demand mediating device 102 notifies the supply and demand mediating terminal 104 of completion of the reduction registration (step S216). The notification of completion of the reduction registration contains the attribute of a consumer (commitment or volunteer) and the bonus point Gd as registered contents. If the reducible energy amount Ad_{(y)} does not exceed F, the supply and demand mediating device 102 notifies the supply and demand mediating terminal 104 of rejection of the reduction registration (step S215).

The supply and demand mediating device 102 makes communication with the multiple supply and demand mediating terminals 104 in the way described above. The supply and demand mediating device 102 determines whether a total reduction amount ΣAd_{(y)} of the reducible energy amounts Ad_{(y)} in the replies from the supply and demand mediating terminals 104 is equal to or more than the requested reduction amount Aa (step S217). The total reduction amount ΣAd_{(y)} mentioned herein is the sum of Ad(y) about all the supply and demand mediating terminals 104 having given replies. If the total reduction amount ΣAd_{(y)} is equal to or more than the requested reduction amount Aa, the supply and demand mediating device 102 notifies all the consumers of completion of the energy reduction registration request (step S220). At the same time, the supply and demand mediating device 102 gives a reduction registration reply to the supply and demand adjusting device 101 (step S221). The reduction registration reply contains the total reduction amount ΣAd_{(y)}, a reduction time zone, a rate of commitment, a bonus point ΣGd_{(y)}, and the processed incentive unit price Bd.

If the total reduction amount ΣAd_{(y)} is not equal to or more than the requested reduction amount Aa, the supply and demand mediating device 102 updates the processed incentive unit price Bd and the bonus point Gd in response to the status of the total reduction amount ΣAd_{(y)} (step S218). Next, the supply and demand mediating device 102 notifies the supply and demand mediating terminal 104 of the updated incentive condition (processed incentive unit price Bd and bonus point Gd) (step S219). Then, the supply and demand mediating device 102 continues accepting a reply to the reduction registration request from the supply and demand mediating terminal 104.

The supply and demand mediating device 102 determines whether a period from current time to time of execution of energy reduction is equal to or less than the period Ts (steps S210, S222). If the period from the current time to the time of execution of energy reduction has become equal to or less than the period Ts, the supply and demand mediating device 102 gives a reduction registration reply to the supply and demand adjusting device 101 regardless of the value of the total reduction amount ΣAd_{(y)} (step S223). The reduction registration reply contains the total reduction amount ΣAd_{(y)}, a reduction time zone, a rate of commitment, the bonus point ΣGd_{(y)}, and the processed incentive unit price Bd. If the aggregator is responsible for payment of the bonus point Gd, the bonus point ΣGd_{(y)} may be omitted from the reply.

Even after the supply and demand mediating terminal 104 receives the notification of completion of the reduction registration from the supply and demand mediating device 102 (step S216), the supply and demand mediating terminal 104 is allowed to change the contents of the reply to the reduction registration request and notify the supply and demand mediating device 102 of the change. However, if invitation for energy reduction has been finished (step S220), change in the reply to the reduction registration request is allowed only in a direction for decreasing the reducible energy amount Ad_{(y)}.

Before the period from the current time to the time of execution of energy reduction becomes equal to the period Ts (step S228), the supply and demand mediating terminal 104 is allowed to change the contents of the reply to the reduction registration request at least in a direction for decreasing the reducible energy amount Ad_{(y)}.

First, the supply and demand mediating terminal 104 determines whether to change the contents of the reply to the reduction registration request (step S224). If the supply and demand mediating terminal 104 determines to change the contents of the reply to the reduction registration request, the flow goes to step S225. In step S225, the supply and demand mediating terminal 104 determines whether the supply and demand mediating device 102 has already finished the reduction registration request. If the supply and demand mediating device 102 has not finished the reduction registration request, the supply and demand mediating terminal 104 gives the supply and demand mediating device 102 a reply to the reduction registration request having changed contents (step S227). At this time, the reducible energy amount Ad_{(y)} can be changed both in a direction for increasing the reducible energy amount Ad_{(y)} and a direction for decreasing the reducible energy amount Ad_{(y)}.

If the supply and demand mediating device 102 has finished the reduction registration request, the supply and demand mediating terminal 104 determines in step S226 whether to change the reducible energy amount Ad_{(y)} in a direction for increasing the reducible energy amount Ad_{(y)}. If the reducible energy amount Ad_{(y)} is not to be changed in a direction for increasing the reducible energy amount Ad_{(y)} (specifically, if the reducible energy amount Ad_{(y)} is to be changed in a direction for decreasing the reducible energy amount Ad_{(y)}, the supply and demand mediating terminal 104 gives a reply to the reduction registration request having contents changed in this way (step S227). Meanwhile, if the supply and demand mediating device 102 has finished the reduction registration request, it is not allowed to change the reducible energy amount Ad_{(y)} in a direction for increasing the reducible energy amount Ad_{(y)}.

If the invitation for energy reduction has been finished when the supply and demand mediating device 102 receives the reduction registration reply having the changed contents from the supply and demand mediating terminal 104, the supply and demand mediating device 102 notifies all the consumers that energy reduction registration request is to be restarted, if necessary (steps S212, S213).

If a consumer who has selected commitment as an attribute changes the reducible energy amount Ad_{(y)} in a direction for decreasing the reducible energy amount Ad_{(y)}, if the reduction registration request itself is canceled, or if an attribute is changed from commitment to volunteer, for example, the aggregator or the utility company may impose a penalty on the consumer. A condition for a penalty is determined in consideration of a contract made between the aggregator or the utility company and the consumer or in terms of service.

The supply and demand adjusting device 101 determines whether a period from current time to time of execution of energy reduction is equal to or less than the period Ts (steps S229). If the period from the current time to the time of execution of energy reduction has become equal to or less than the period Ts, the supply and demand adjusting device 101 finishes the supply and demand adjusting sequence. If the period from the current time to the time of execution of energy reduction is not equal to or less than the period Ts, the supply and demand adjusting device 101 determines whether the total reduction amount ΣAd_{(y)} in the reduction registration reply from the supply and demand mediating device 102 is equal to or more than the requested reduction amount Aa (step S230). If the total reduction amount ΣAd_{(y)} is not equal to or more than the requested reduction amount Aa, the supply and demand adjusting device 101 determines whether update of the incentive target information (incentive target unit price Bt and incentive adjustment range R) is allowable. If update of the incentive target information is not allowable, the flow goes to a stage before step S204. If update of the incentive target information is allowable, the supply and demand adjusting device 101 updates the incentive target information (step S232). If the incentive target information is updated, the supply and demand adjusting device 101 executes the supply and demand adjusting sequence again.

The supply and demand adjusting device 101 determines whether to request the supply and demand mediating device 102 to give a reduction registration reply (step S204). If this request is necessary, the supply and demand adjusting device 101 requests the supply and demand mediating device 102 to give a reduction registration reply (step S205). The supply and demand mediating device 102 determines whether request for a reduction registration reply has been received from the supply and demand adjusting device 101 (step S206). If the supply and demand mediating device 102 determines that this request has been received, the supply and demand mediating device 102 gives a reduction registration reply to the supply and demand adjusting device 101 (step S207). In response to receipt of the reduction registration reply, the supply and demand adjusting device 101 makes a determination as to a need to change the reduction target (step S208). If the supply and demand adjusting device 101 determines that there is a need to change the reduction target, the supply and demand adjusting device 101 notifies the supply and demand mediating device 102 of a changed reduction registration target (step S209).

Then, the supply and demand adjusting sequence is finished. As shown in FIG. 5, after the supply and demand adjusting sequence (step S200) is finished, the supply and demand adjusting device 101 determines whether decreasing the requested reduction amount Aa to a more precise value Ab (specifically, a value Ab closer to the target value) is allowable (step S6). If decreasing the requested reduction amount Aa is allowable, the supply and demand adjusting device 101 sets an adopted reduction value Ab as Aa−ΔAb (step S8). If decreasing the requested reduction amount Aa is not allowable, the supply and demand adjusting device 101 sets Aa as the adopted reduction value Ab (step S7).

The supply and demand adjusting device 101 notifies the supply and demand mediating device 102 of the adopted reduction value Ab as a new requested reduction value (step S9). At this time, a requested reduction amount of energy can be confirmed with a certain degree of precision. Thus, in the subsequent adoption notifying sequence (step S300), the supply and demand mediating device 102 adopts a consumer appropriate for the adopted reduction value Ab as a target of incentive payment.

### Adoption Notifying Sequence

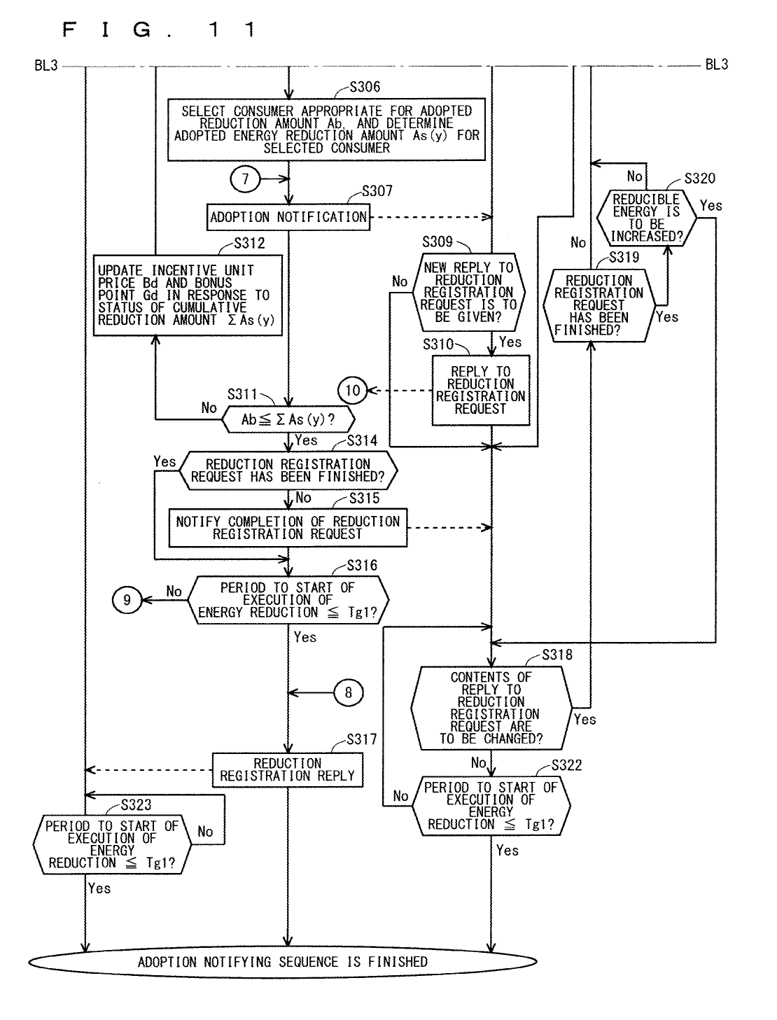

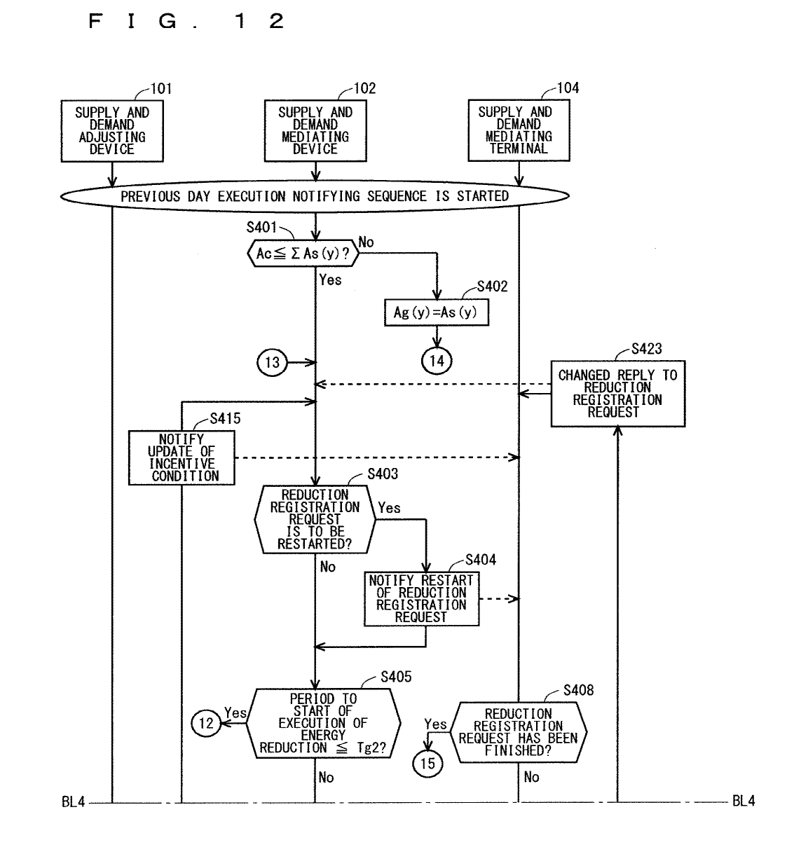

FIGS. 10 and 11 show an example of the adoption notifying sequence executed between the supply and demand adjusting device 101, the supply and demand mediating device 102, and the supply and demand mediating terminal 104. FIGS. 10 and 11 are connected through a dashed part identified by BL3 to form one drawing.

When the adoption notifying sequence is started, the supply and demand mediating device 102 determines whether the adopted reduction value Ab is equal to or less than the total reduction amount ΣAd_{(y)} (step S301).

If the adopted reduction value Ab is equal to or less than the total reduction amount ΣAd_{(y)}, the supply and demand mediating device 102 adopts a consumer appropriate for the adopted reduction value Ab, and determines an adopted energy reduction amount As_{(y)} for this consumer (step S306). As a specific example, the supply and demand mediating device 102 selects consumers having given replies to the reduction registration request in the supply and demand adjusting sequence in decreasing speed of giving the replies. Then, the supply and demand mediating device 102 adopts consumers up to a stage when a total reduction amount of the selected consumers has reached the adopted reduction value Ab as targets of incentive payment. Then, the supply and demand mediating device 102 deteiniines the reducible energy amount Ad_{(y)} as the adopted energy reduction amount As_{(y)} for each consumer. The foregoing method of adopting a consumer appropriate for the adopted reduction value Ab is to be deteimined based on a contract made between the aggregator and the consumer. The adoption method is not limited to the foregoing method.

If the adopted reduction value Ab is not equal to or less than the total reduction amount ΣAd_{(y)}, the supply and demand mediating device 102 adopts all the consumers having given replies in the demand adjusting sequence, and determines the reducible energy amount Ad_{(y)} as it is as the adopted energy reduction amount As_{(y)} (step S302).

Next, the supply and demand mediating device 102 notifies the supply and demand mediating terminal 104 of the adoption (step S307). The adoption notification contains the presence or absence of adoption of a corresponding consumer. The adopted consumer receives notification that the reducible energy amount Ad_{(y)} this consumer has given in the reply in the demand adjusting sequence is to be adopted as it is as the adopted energy reduction amount As_{(y)}, which is to be a target of incentive payment.

Then, the supply and demand mediating device 102 continues accepting a reply to the energy reduction registration request from a consumer (supply and demand mediating terminal 104). If a new consumer gives a reply to the reduction registration request (step S310), the supply and demand mediating device 102 goes to a stage before step S301. Like in the supply and demand adjusting sequence, this reply to the reduction registration request contains the reducible energy amount Ad_{(y)}, a reduction time zone, and an attribute (commitment or volunteer, and previous day or current day). The supply and demand mediating device 102 notifies this consumer of the adopted energy reduction amount As_{(y)} and gives this consumer a notification that the consumer has been adopted as a target of incentive payment (step S307). In order for the consumer to give the reply to the reduction registration request, the demand mediating terminal 104 first determines whether the reduction registration request has been finished (step S308). If the reduction registration request has not been finished, the demand mediating terminal 104 determines whether to give a new reply to the reduction registration request (step S309). If the demand mediating terminal 104 determines to give a new reply to the reduction registration request, the demand mediating terminal 104 gives a reply to the reduction registration request (step S310).

The supply and demand mediating device 102 determines whether a total reduction amount ΣAs_{(y)} of the adopted energy reduction amounts As_{(y)} determined for a consumer (supply and demand mediating devices 104) is equal to or more than the adopted reduction value Ab (step S311). If the total reduction amount ΣA_{(y)} is equal to or more than the adopted reduction value, the supply and demand mediating device 102 determines whether the reduction registration request has been finished for all the consumers (step S314). If the reduction registration request has not been finished, the supply and demand mediating device 102 gives all the consumers a notification that the energy reduction registration request has been finished (step S315).

If the total reduction amount ΣAs_{(y)} is not equal to or more than the adopted reduction value Ab, the supply and demand mediating device 102 updates the processed incentive unit price Bd and the bonus point Gd in response to the status of the total reduction amount ΣAs_{(y)} (step S312). Next, the supply and demand mediating device 102 notifies the supply and demand mediating terminal 104 of the updated incentive condition (processed incentive unit price Bd and bonus point Gd) (step S313). Then, the supply and demand mediating device 102 continues accepting a reply to the reduction registration request from the supply and demand mediating terminal 104. Unless a period to time of execution of energy reduction becomes equal to or less than the period Tg1, the foregoing procedure is continued until a total of the adopted energy reduction amounts As_{(y)} reaches the adopted reduction value Ab.

The supply and demand mediating device 102 determines whether a period from current time to time of execution of energy reduction has become equal to or less than the period Tg1 (steps S305, S316). The period Tg1 is set so as to elapse at particular time on a day previous to a day of execution of energy reduction. If the period from the current time to the time of execution of energy reduction has become equal to or less than the period Tg1, the supply and demand mediating device 102 gives a reduction registration reply to the supply and demand adjusting device 101 regardless of the value of the total reduction amount ΣAs_{(y)} (step S317). The reduction registration reply contains the total reduction amount ΣAs_{(y)}, a reduction time zone, a rate of commitment, the bonus point ΣGd_{(y)}, and the processed incentive unit price Bd. If the aggregator is responsible for payment of the bonus point Gd, the bonus point ΣGd_{(y)} may be omitted from the reply.

Even after the supply and demand mediating terminal 104 receives the completion notification about the reduction registration request from the supply and demand mediating device 102 (step S315), the supply and demand mediating terminal 104 is allowed to change the contents of the reply to the reduction registration request and notify the supply and demand mediating device 102 of the change. However, if invitation for energy reduction has been finished, change in the reply to the reduction registration request is allowed only in a direction for decreasing the reducible energy amount Ad_{(y)}.

Before the period from the current time to the time of execution of energy reduction becomes equal to the period Tg1 (step S322), the supply and demand mediating terminal 104 is allowed to change the contents of the reply to the reduction registration request at least in a direction for decreasing the reducible energy amount Ad_{(y)}.

First, the supply and demand mediating terminal 104 determines whether to change the contents of the reply to the reduction registration request (step S318). If the supply and demand mediating terminal 104 determines to change the contents of the reply to the reduction registration request, the flow goes to step S319. In step S319, the supply and demand mediating terminal 104 determines whether the supply and demand mediating device 102 has already finished the reduction registration request. If the supply and demand mediating device 102 has not finished the reduction registration request, the supply and demand mediating terminal 104 gives the supply and demand mediating device 102 a reply to the reduction registration request having changed contents (step S321). At this time, the reducible energy amount Ad_{(y)} can be changed both in a direction for increasing the reducible energy amount Ad_{(y)} and a direction for decreasing the reducible energy amount Ad_{(y)}. The supply and demand mediating device 102 determines the reducible energy amount Ad_{(y)} as it is as the adopted energy reduction amount As_{(y)}, and notifies a consumer of the adopted energy reduction amount As_{(y)}.

If the supply and demand mediating device 102 has finished the reduction registration request, the supply and demand mediating terminal 104 determines in step S320 whether to change the reducible energy amount Ad_{(y)} in a direction for increasing the reducible energy amount Ad_{(y)}. If the reducible energy amount Ad_{(y)} is not to be changed in a direction for increasing the reducible energy amount Ad_{(y)} (specifically, if the reducible energy amount Ad_{(y)} is to be changed in a direction for decreasing the reducible energy amount Ad_{(y)}, the supply and demand mediating terminal 104 gives a reply to the reduction registration request having contents changed in this way (step S321). Meanwhile, if the supply and demand mediating device 102 has finished the reduction registration request, it is not allowed to change the reducible energy amount Ad_{(y)} in a direction for increasing the reducible energy amount Ad_{(y)}. In response to receipt of the reduction registration reply having the changed contents from the supply and demand mediating terminal 104, the supply and demand mediating device 102 determines the changed reducible energy amount Ad_{(y)} as it is as the adopted energy reduction amount As_{(y)}, and notifies a consumer of the adopted energy reduction amount As_{(y)}.

If the invitation for energy reduction has been finished when the supply and demand mediating device 102 receives a reduction registration reply having the changed contents from the supply and demand mediating terminal 104, the supply and demand mediating device 102 notifies all the consumers that energy reduction registration request is to be restarted, if necessary (steps S303, S304).

If a consumer who has selected commitment as an attribute changes the reducible energy amount Ad_{(y)} in a direction for decreasing the reducible energy amount Ad_{(y)}, if the reduction registration request itself is canceled, or if an attribute is changed from commitment to volunteer, for example, the aggregator or the utility company may impose a penalty on the consumer. A condition for a penalty is determined in consideration of a contract made between the aggregator or the utility company and the consumer or in terms of service.

The adopted energy reduction amount As_{(y)} is a value at which the amount of an incentive to be paid to the consumer adopted in the adoption sequence is guaranteed under a given condition. Specifically, an energy reduction amount (energy reduction reference value Ag_{(y)} described later) finally required in the previous day execution sequence following the adoption sequence is determined. Even if the amount of energy to be actually reduced by a consumer falls below the adopted reduction amount As_{(y)}, the consumer is still allowed to be blessed with an incentive corresponding to the reduction amount As_{(y)} as long as the actually reduced energy amount is equal to or more than the energy reduction reference value Ag_{(y)}.

The demand adjusting device 101 determines whether a period from current time to time of execution of energy reduction is equal to or less than the period Tg1 (steps S323). If the period from the current time to the time of execution of energy reduction has become equal to or less than the period Tg1, the supply and demand adjusting device 101 finishes the adoption notifying sequence.

Then, the adoption notifying sequence is finished. As shown in FIG. 5, after the adoption notifying sequence (step S300) is finished, the supply and demand adjusting device 101 determines whether decreasing the adopted reduction value Ab to a more precise value Ac (specifically, a value Ac closer to the target value) is allowable (step S10). If decreasing the adopted reduction value Ab is allowable, the supply and demand adjusting device 101 sets a reduction reference value Ac as Ab−ΔAc (step S12). If decreasing the adopted reduction value Ab is not allowable, the supply and demand adjusting device 101 sets Ab as the reduction reference value Ac (step S11).

The supply and demand adjusting device 101 notifies the supply and demand mediating device 102 of the reduction reference value Ac as a new requested reduction value (step S13). In the subsequent previous day execution notifying sequence (step

S400) and current day execution sequence (step S500), the supply and demand mediating device 102 determines the energy reduction reference value Ag_{(y)} for the consumer adopted in the adoption notifying sequence (step S300) in such a manner that the energy reduction reference value Ag_{(y)} becomes equal to or less than the adopted energy reduction amount As_{(y)}, based on the reduction reference value Ac. An actual value of energy reduction about the consumer adopted in the adoption sequence is required to attain this reduction reference value Ag_{(y)} at minimum. This is a condition for avoiding a penalty for the consumer adopted in the adoption notifying sequence and having a commitment attribute. The reduction reference value Ag_{(y)}, is determined to be equal to or less than the adopted reduction amount As_{(y)}. This works advantageously for the consumer as request for energy reduction is moderated in the previous day execution notifying sequence and the current day execution sequence while an incentive is assured through the adoption sequence. This also works advantageously for the utility company as the amount of energy consumed by the consumer is increased within a range that achieves balance of supply and demand, which leads to sales growth.

### Previous Day Execution Notifying Sequence

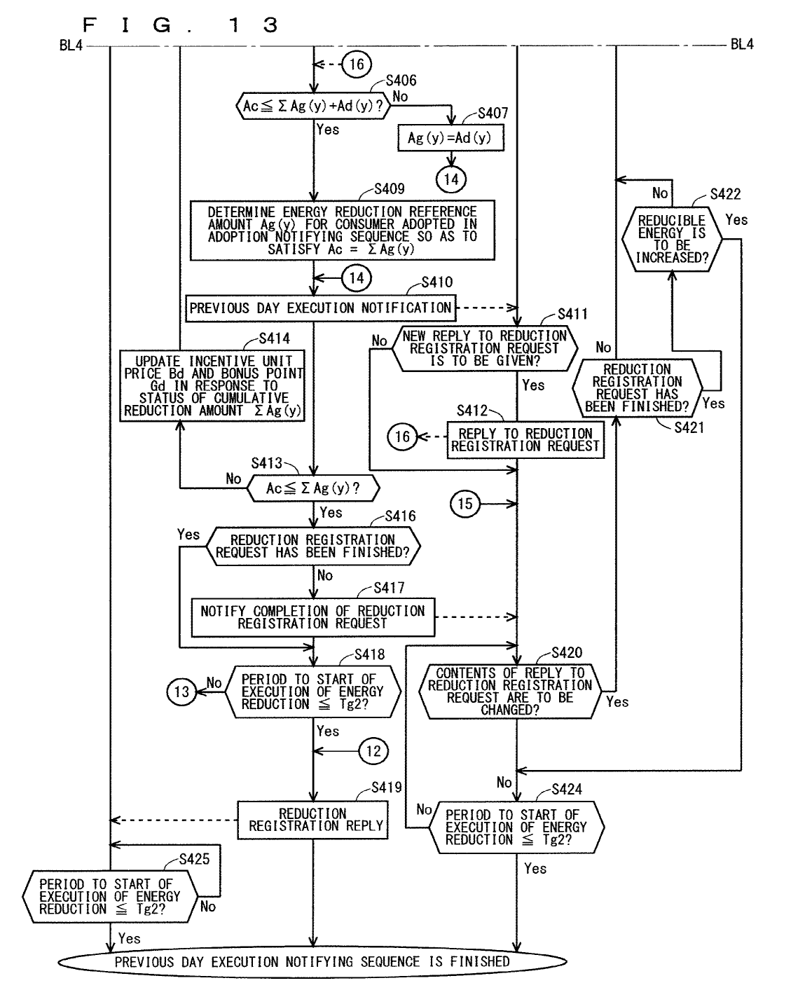

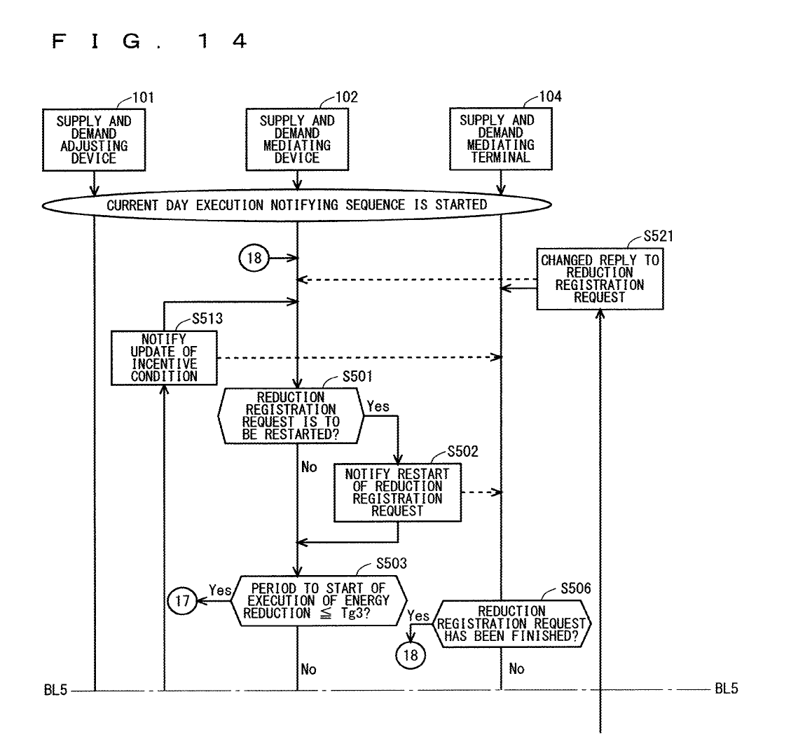

FIGS. 12 and 13 show an example of the previous day execution notifying sequence executed between the supply and demand adjusting device 101, the supply and demand mediating device 102, and the supply and demand mediating terminal 104. FIGS. 12 and 13 are connected through a dashed part identified by BL4 to form one drawing.

When the previous day execution notifying sequence is started, the supply and demand mediating device 102 determines whether the reduction reference value Ac is equal to or less than the total reduction amount ΣAs_{(y)} (step S401). If the reduction reference value Ac is equal to or less than the total reduction amount ΣAs_{(y)}, the supply and demand mediating device 102 determines the energy reduction reference value Ag_{(y)} for the consumer adopted in the adoption notifying sequence (step S409). The energy reduction reference value Ag_{(y)} for a consumer having an attribute “previous day” is expressed as Ag1_{(y)}. The energy reduction reference value Ag_{(y)} for a consumer having an attribute “current day” is expressed as Ag2_{(y)}. If the energy reduction reference values Ag1_{(y)} and Ag2_{(y)} are not required to be distinguished for any particular purpose, Ag1_{(y)} and Ag2_{(y)} are simply called Ag_{(y)}.

The energy reduction reference value Ag_{(y)} for each consumer is determined to satisfy the following: total reduction amount ΣAg_{(y)}=Ac. More specifically, the reduction reference value Ac is a value of equal to or less than the total reduction amount ΣAs_{(y)}. Thus, the adopted reduction amounts As_{(y)} for all the consumers are decreased uniformly and a resultant value is employed as Ag_{(y)}, for example. Alternatively, Ag_{(y)} may be determined by decreasing the adopted reduction amounts As_{(y)} by giving priority to consumers having given replies to the reduction registration request in the supply and demand adjusting sequence in decreasing speed of giving the replies. A method of determining the energy reduction reference value Ag_{(y)} is not limited to the above-described examples but it may be determined in consideration of a contract made between the aggregator or the utility company and the consumer or in terms of service.

If the reduction reference value Ac is not equal to or less than the total reduction amount ΣAs_{(y)}, the supply and demand mediating device 102 determines As_{(y)} as it is as Ag_{(y)} for the consumer adopted in the adoption sequence (step S402).

Then, the supply and demand mediating device 102 gives a previous day execution notification to the supply and demand mediating terminal 104 installed on a consumer adopted in the adoption sequence and having an attribute “previous day” (step S410). The previous day execution notification contains the reduction reference amount Ag1_{(y)}.

Next, the supply and demand mediating device 102 determines whether the reduction reference value Ac is equal to or less than the total reduction amount ΣAg_{(y)} (step S413). If the reduction reference value Ac is equal to or less than the total reduction amount ΣAg_{(y)}, the supply and demand mediating device 102 determines whether the reduction registration request has been finished for all the consumers (step S416). If the reduction registration request has not been finished, the supply and demand mediating device 102 gives all the consumers a notification that the energy reduction registration request has been finished (step S417).

If the reduction reference value Ac is not equal to or less than the total reduction amount ΣAg_{(y)}, the supply and demand mediating device 102 updates the processed incentive unit price Bd and the bonus point Gd in response to the status of the total reduction amount ΣAg_{(y)} (step S414). Next, the supply and demand mediating device 102 notifies the supply and demand mediating terminal 104 of the updated incentive condition (processed incentive unit price Bd and bonus point Gd) (step S415). Then, the supply and demand mediating device 102 continues accepting a reply to the reduction registration request from the supply and demand mediating terminal 104.

In order for a consumer to give a reply to the reduction registration request, the demand mediating terminal 104 first determines whether the reduction registration request has been finished (step S408). If the reduction registration request has not been finished, the demand mediating terminal 104 determines whether to give a new reply to the reduction registration request (step S411). If the demand mediating terminal 104 determines to give a new reply to the reduction registration request, the demand mediating terminal 104 gives a new reply to the reduction registration request (step S412).

If a new consumer gives a reply to the reduction registration request (step S412), and if a value obtained by adding the reducible energy Ad_{(y)} in the reply to ΣAg_{(y)} is equal to or more than Ac (step S406), the supply and demand mediating device 102 determines the energy reduction reference value Ag_{(y)} for the new consumer so as to satisfy the following: ΣAg_{(y)}=Ac (step S409). Meanwhile, if the value obtained by adding the reducible energy Ad_{(y)} in the reply to ΣAg_{(y)} is not equal to or more than Ac, the supply and demand mediating device 102 determines the reducible energy As_{(y)} in the reply given from the new consumer as it is as the energy reduction reference value Ag_{(y)} (step S407).

The supply and demand mediating device 102 gives a previous day execution notification to the supply and demand mediating terminal 104 installed on a consumer adopted in the adoption sequence and having an attribute “previous day” (step S410). The previous day execution notification contains the reduction reference amount Ag1_{(y)}.

Unless a period to time of execution of energy reduction becomes equal to or less than the period Tg2, the foregoing procedure is continued until the total ΣAg_{(y)} of the adopted energy reduction amounts reaches the reduction reference value Ac.

The supply and demand mediating device 102 determines whether a period from current time to time of execution of energy reduction has become equal to or less than the period Tg2 (steps S405, S418). The period Tg2 is set so as to elapse at particular time on a current day of execution of energy reduction. If the period from the current time to the time of execution of energy reduction has become equal to or less than the period Tg2, the supply and demand mediating device 102 gives a reduction registration reply to the supply and demand adjusting device 101 regardless of the value of the total reduction amount ΣAg_{(y)} (step S419). The reduction registration reply contains the total reduction amount ΣAg_{(y)}, a reduction time zone, a rate of commitment, the bonus point ΣGd_{(y)}, and the processed incentive unit price Bd. If the aggregator is responsible for payment of the bonus point Gd, the bonus point ΣGd_{(y)} may be omitted from the reply.

Even after the supply and demand mediating terminal 104 receives the completion notification about the reduction registration request from the supply and demand mediating device 102 (step S417), the supply and demand mediating terminal 104 is allowed to change the contents of the reply to the reduction registration request and notify the supply and demand mediating device 102 of the change. However, if invitation for energy reduction has been finished, change in the reply to the reduction registration request is allowed only in a direction for decreasing the reducible energy amount Ad_{(y)}.

Before the period from the current time to the time of execution of energy reduction becomes equal to or less than the period Tg2 (step S424), the supply and demand mediating terminal 104 is allowed to change the contents of the reply to the reduction registration request at least in a direction for decreasing the reducible energy amount Ad_{(y)}.

First, the supply and demand mediating terminal 104 determines whether to change the contents of the reply to the reduction registration request (step S420). If the supply and demand mediating terminal 104 determines to change the contents of the reply to the reduction registration request, the flow goes to step S421. In step S421, the supply and demand mediating terminal 104 determines whether the supply and demand mediating device 102 has already finished the reduction registration request. If the supply and demand mediating device 102 has not finished the reduction registration request, the supply and demand mediating terminal 104 gives the supply and demand mediating device 102 a reply to the reduction registration request having changed contents (step S423). At this time, the reducible energy amount Ad_{(y)} can be changed both in a direction for increasing the reducible energy amount Ad_{(y)} and a direction for decreasing the reducible energy amount Ad_{(y)}. The supply and demand mediating device 102 determines the energy reduction reference value Ag_{(y)} in the same way as that described above based on the changed reducible energy amount Ad_{(y)}, and notifies the consumer of the determined energy reduction reference value Ag_{(y)}.

If the supply and demand mediating device 102 has finished the reduction registration request, the supply and demand mediating terminal 104 determines in step S422 whether to change the reducible energy amount Ad_{(y)} in a direction for increasing the reducible energy amount Ad_{(y)}. If the reducible energy amount Ad_{(y)} is not to be changed in a direction for increasing the reducible energy amount Ad_{(y)} (specifically, if the reducible energy amount Ad_{(y)} is to be changed in a direction for decreasing the reducible energy amount Ad_{(y)}), the supply and demand mediating terminal 104 gives a reply to the reduction registration request having contents changed in this way (step S423). Meanwhile, if the supply and demand mediating device 102 has finished the reduction registration request, it is not allowed to change the reducible energy amount Ad_{(y)} in a direction for increasing the reducible energy amount Ad_{(y)}. In response to receipt of the reduction registration reply having the changed contents from the supply and demand mediating terminal 104, the supply and demand mediating device 102 determines the energy reduction reference value Ag_{(y)} in the same way as that described above based on the changed reducible energy Ad_{(y)}, and notifies a consumer of the determined energy reduction reference value Ag_{(y)}.

If the energy reduction registration request has been finished when the supply and demand mediating device 102 receives a reduction registration reply having the changed contents from the supply and demand mediating terminal 104, the supply and demand mediating device 102 notifies all the consumers that energy reduction registration request is to be restarted, if necessary (steps S403, S404).

If a consumer who has selected commitment as an attribute changes the reducible energy amount Ad_{(y)} In a direction for decreasing the reducible energy amount Ad_{(y)}, if the reduction registration request itself is canceled, or if an attribute is changed from commitment to volunteer, for example, the aggregator or the utility company may impose a penalty on the consumer. A condition for a penalty is determined in consideration of a contract made between the aggregator or the utility company and the consumer or in terms of service.

The demand adjusting device 101 determines whether a period from current time to time of execution of energy reduction is equal to or less than the period Tg2 (steps S425). If the period from the current time to the time of execution of energy reduction has become equal to or less than the period Tg2, the supply and demand adjusting device 101 finishes the previous day execution notifying sequence.

### Current Day Execution Notifying Sequence

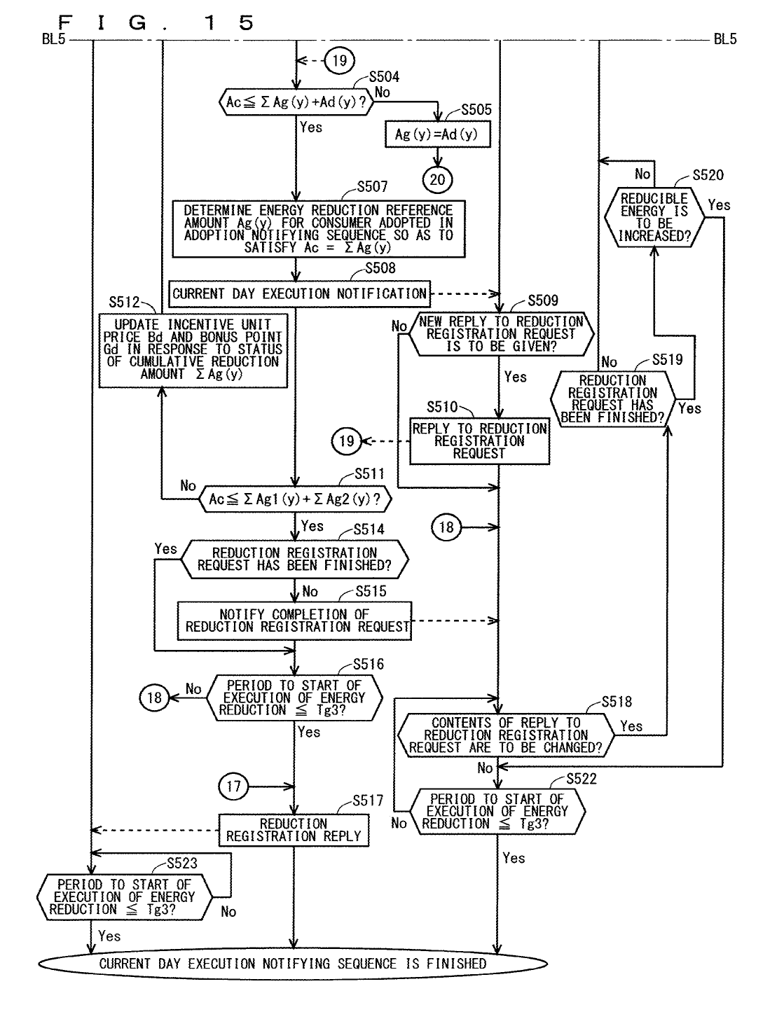

FIGS. 14 and 15 show an example of the current day execution notifying sequence executed between the supply and demand adjusting device 101, the supply and demand mediating device 102, and the supply and demand mediating terminal 104. FIGS. 14 and 15 are connected through a dashed part identified by BLS to form one drawing.

The supply and demand mediating device 102 determines the energy reduction reference value Ag_{(y)} for each consumer so as to satisfy the following: total reduction amount ΣAg_{(y)}=Ac (step S507). The energy reduction reference value Ag_{(y)} is determined by the same method as the above-described method of the previous day execution notifying sequence.

Then, the supply and demand mediating device 102 gives a current day execution notification to the supply and demand mediating terminal 104 installed on a consumer adopted in the adoption sequence and having an attribute “current day” (step S508). The current day execution notification contains the reduction reference amount Ag2_{(y)}.

Next, the supply and demand mediating device 102 determines whether the reduction reference value Ac is equal to or less than the total reduction amount ΣAg_{(y)} (step S511). Here, ΣAg_{(y)} is a value obtained by adding ΣAg1_{(y)} and ΣAg2_{(y)}. If the reduction reference value Ac is equal to or less than the total reduction amount ΣAg_{(y)}, the supply and demand mediating device 102 determines whether the reduction registration request has been finished for all the consumers (step S514). If the reduction registration request has not been finished, the supply and demand mediating device 102 gives all the consumers a notification that the energy reduction registration request has been finished (step S515).

If the reduction reference value Ac is not equal to or less than the total reduction amount ΣAg_{(y)}, the supply and demand mediating device 102 updates the processed incentive unit price Bd and the bonus point Gd in response to the status of the total reduction amount ΣAg_{(y)} (step S512). Next, the supply and demand mediating device 102 notifies the supply and demand mediating terminal 104 of the updated incentive condition (processed incentive unit price Bd and bonus point Gd) (step S513). Then, the supply and demand mediating device 102 continues accepting a reply to the reduction registration request from the supply and demand mediating terminal 104.

In order for a consumer to give a reply to the reduction registration request, the demand mediating terminal 104 first determines whether the reduction registration request has been finished (step S506). If the reduction registration request has not been finished, the demand mediating terminal 104 determines whether to give a new reply to the reduction registration request (step S509). If the demand mediating terminal 104 determines to give a new reply to the reduction registration request, the demand mediating terminal 104 gives a new reply to the reduction registration request (step S510).

If a new consumer gives a reply to the reduction registration request (step S510), and if a value obtained by adding the reducible energy Ad_{(y)} in the reply to ΣAg_{(y)} is equal to or more than Ac (step S504), the supply and demand mediating device 102 determines the energy reduction reference value Ag_{(y)} for the new consumer so as to satisfy the following: ΣAg_{(y)}=Ac (step S507). Meanwhile, if the value obtained by adding the reducible energy As_{(y)} in the reply to ΣAg_{(y)} is not equal to or more than Ac, the supply and demand mediating device 102 determines the reducible energy As_{(y)} in the reply given from the new consumer as it is as the energy reduction reference value Ag_{(y)} (step S505).

The supply and demand mediating device 102 gives a current day execution notification to the supply and demand mediating terminal 104 installed on a consumer adopted in the adoption sequence and having an attribute “current day” (step S508). The current day execution notification contains the reduction reference amount Ag2_{(y)}.

Unless a period to time of execution of energy reduction becomes equal to a period Tg3, the foregoing procedure is continued until the total ΣAg_{(y)} of the adopted energy reduction amounts reaches the reduction reference value Ac.

The supply and demand mediating device 102 determines whether a period from current time to time of execution of energy reduction has become equal to or less than the period Tg3(steps S503, S516). The period Tg3 is set so as to elapse at particular time on a current day of execution of energy reduction. The particular time corresponding to the period Tg3 is closer to start time of energy reduction on the current day of execution the energy reduction than the above-described particular time corresponding to the period Tg2. If the period from the current time to the time of execution of energy reduction has become equal to or less than the period Tg3, the supply and demand mediating device 102 gives a reduction registration reply to the supply and demand adjusting device 101 regardless of the value of the total reduction amount ΣAg_{(y)} (step S517). The reduction registration reply contains the total reduction amount ΣAg_{(y)}, a reduction time zone, a rate of commitment, the bonus point ΣGd_{(y)}, and the processed incentive unit price Bd. If the aggregator is responsible for payment of the bonus point Gd, the bonus point ΣGd_{(y)} may be omitted from the reply.

Even after the supply and demand mediating terminal 104 receives the completion notification about the reduction registration request from the supply and demand mediating device 102 (step S515), the supply and demand mediating terminal 104 is allowed to change the contents of the reply to the reduction registration request and notify the supply and demand mediating device 102 of the change. However, if invitation for energy reduction has been finished, change in the reply to the reduction registration request is allowed only in a direction for decreasing the reducible energy amount Ad_{(y)}.

Before the period from the current time to the time of execution of energy reduction becomes equal to or less than the period Tg3 (step S522), the supply and demand mediating terminal 104 is allowed to change the contents of the reply to the reduction registration request at least in a direction for decreasing the reducible energy amount Ad_{(y)}. In the current day execution notifying sequence, change in the contents of the reply to the reduction registration request is allowed only for a consumer having an attribute “current day.” Steps S518 to S522 will not be described as these steps are similar to steps S420 to S424 respectively in the previous day execution notifying sequence. Steps S501 and S502 will not be described as these steps are similar to steps S403 and S404 respectively in the previous day execution notifying sequence.

The demand adjusting device 101 determines whether a period from current time to time of execution of energy reduction is equal to or less than the period Tg3 (steps S523). If the period from the current time to the time of execution of energy reduction has become equal to or less than the period Tg3, the supply and demand adjusting device 101 finishes the current day execution notifying sequence.

As shown in FIG. 6, when the current day execution notifying sequence (step S500) is finished, the supply and demand adjusting device 101 registers reduction plan information with the information database 103 (step S14). More specifically, the supply and demand adjusting device 101 registers parameters including the total reduction amount ΣAg_{(y)}, the incentive target unit price Bt, the incentive adjustment range R, a rate of commitment, and the processed incentive unit price Bd as the reduction plan information with the information database 103, and acquires a reduction plan ID.

Then, the supply and demand adjusting device 101 notifies the supply and demand mediating device 102 of a reduction plan result (step S15). The reduction plan result contains the reduction plan ID. The supply and demand mediating device 102 notifies the consumer (supply and demand mediating terminal 104) adopted in the adoption notifying sequence of completion of the reduction plan (step S16). Then, the reduction plan is finished.

The total reduction amount ΣAg_{(y)} not reaching the energy reduction reference value Ac means that collection of energy reduction has not been finished successfully within a predetermined period. In this case, the utility company takes emergency action such as scheduled power outage.

FIG. 4 shows an example of a table for management of reduction plan information in the information database 103. As shown in FIG. 4, a reduction plan ID is given to each reduction plan and each reduction plan ID can be used for referring to a requested reduction amount, a total reduction amount, date and time of execution of reduction, an incentive target unit price, an actual incentive unit price (specifically, finally processed incentive unit price Bd), an incentive adjustment range, and a rate of commitment.

The reduction plan information may be registered not only with the information database 103 but also with the storage 25 in the supply and demand mediating device 102. In this case, the supply and demand adjusting device 101 notifies a reduction plan result without a reduction plan ID. After the supply and demand mediating device 102 registers a reduction plan and acquires a reduction plan ID, the supply and demand mediating device 102 gives a reply to the reduction plan result containing the reduction plan ID to the supply and demand adjusting device 101.

### Effect

The supply and demand adjusting device 101 according to the embodiment of the present invention works cooperatively with the supply and demand mediating device 102 to adjust energy supply and demand. The supply and demand adjusting device 101 and the supply and demand mediating device 102 are connected in a manner that allows bidirectional communication therebetween. The supply and demand mediating device 102 is connected to the supply and demand mediating terminal 104 provided to a consumer in a manner that allows bidirectional communication therebetween. The supply and demand adjusting device 101 sets a requested reduction amount of energy at date and time when energy usage is scheduled to be reduced to be larger than a target value, and notifies the supply and demand mediating device 102 of the requested reduction amount and the scheduled date and time together. The supply and demand adjusting device 101 receives a total amount of reducible energy reducible by the consumer from the supply and demand mediating device 102 as a reply to the notification. As the scheduled date and time approaches, the supply and demand adjusting device 101 inquires of the supply and demand mediating device 102 about a total amount of reducible energy reducible by the consumer at the time of the inquiry, and receives a reply to the inquiry from the supply and demand mediating device 102. The supply and demand adjusting device 101 decreases the requested reduction amount stepwise so as to make the requested reduction amount approach the target value. Each time the requested reduction amount is decreased, the supply and demand adjusting device 101 notifies the supply and demand mediating device 102 of the resultant requested reduction amount, and receives a reply to the notification from the supply and demand mediating device 102.

The supply and demand adjusting device 101 according to the embodiment of the present invention sets a requested reduction amount of energy to be larger than a target value, and notifies the supply and demand mediating device 102 of the requested reduction amount. Then, the supply and demand adjusting device 101 decreases the requested reduction amount of energy further within an allowable range so as to coincide with timing earlier than the date and time when energy is scheduled to be reduced (a day of execution of energy reduction) by a predetermined period and to coincide with timing closer to the day of execution of energy reduction, and notifies the supply and demand mediating device 102 of the resultant requested reduction amount. In this way, the requested reduction amount of energy is initially set to be larger than the target value. As the day of execution of energy reduction approaches, the requested reduction amount is decreased stepwise. This makes it possible to reduce the likelihood of shortage of an energy reduction amount on the day of execution of energy reduction. Further, the amount of energy to be actually reduced is allowed to match the target value with a high degree of precision, so that excessive energy reduction exceeding the target value is unlikely to occur. Preventing energy reduction exceeding the target value makes it possible to cut redundant incentive cost.

As the day of execution of energy reduction approaches, the supply and demand adjusting device 101 decreases the requested reduction amount of energy stepwise. Thus, a change in a reducible energy amount made by the consumer is allowable, even if this change is made during making of a reduction plan. The consumer is allowed to change a reducible energy amount even when the supply and demand adjusting device 101 collects energy reduction. This moderates limitation on the consumer to allow the consumer to change a reducible energy amount more easily.

In the supply and demand adjusting device 101 according to the embodiment of the present invention, as the scheduled date and time approaches, the target value may be changed to a more precise target value.

The target value determined initially by the supply and demand adjusting device 101 has a large error (plus or minus α). In this embodiment, the error in this target value can be decreased stepwise. In this embodiment, an initial requested reduction amount of energy is set at a value obtained by adding the error a to the target value. Then, as the date and time of execution of energy reduction approaches, the precision of the requested reduction amount of energy is increased, so that the target value can be set at a value with a smaller error of plus or minus β (<α). When the precision is increased to a certain degree, specifically, when the error β becomes smaller than α by a certain degree, the target value is reset to a new value. By doing so, a resultant requested reduction amount of energy can be a more proper and more precise amount than the target value initially set.

The supply and demand adjusting device 101 according to the embodiment of the present invention notifies the supply and demand mediating device 102 of a condition for an incentive to be given to the consumer when the supply and demand mediating device 102 is notified of the requested reduction amount. The supply and demand adjusting device 101 changes the condition for the incentive in a manner that depends on a relationship between the total amount of reducible energy and the requested reduction amount.

For example, the supply and demand adjusting sequence is started with a relatively low incentive unit price. If the total amount of reducible energy does not reach the requested reduction amount while the day of execution of energy reduction approaches, the incentive unit price is increased. By doing so, the total amount of reducible energy is allowed to match the requested reduction amount precisely with a proper incentive unit price.

The supply and demand adjusting system according to the embodiment of the present invention includes the supply and demand adjusting device 101, and the supply and demand mediating device 102 that works cooperatively with the supply and demand adjusting device 101 to adjust energy supply and demand. If the supply and demand mediating device 102 receives the requested reduction amount, the scheduled date and time, and a condition for the incentive from the supply and demand adjusting device 101, the supply and demand mediating device 102 determines an incentive unit price corresponding to the scheduled date and time within a range of the condition for the incentive, and notifies the supply and demand mediating terminal 104 of the scheduled date and time and the incentive unit price. The supply and demand mediating device 102 receives a reply to the notification from the supply and demand mediating terminal 104. Even after the reply is received from the supply and demand mediating terminal 104, the supply and demand mediating device 102 accepts change in contents of the reply at least in a direction for decreasing an energy reduction amount. If a total energy reduction amount collected in the reply from the supply and demand mediating terminal 104 reaches the requested reduction amount, the supply and demand mediating device 102 notifies the supply and demand mediating terminal 104 of stop of energy reduction request. In the supply and demand adjusting system according to this embodiment, as the day of execution of energy reduction approaches, the supply and demand adjusting device 101 decreases the target value requested reduction amount stepwise.

Thus, even if the consumer changes the reducible energy amount, an aggregator (supply and demand mediating device 102) is allowed to respond to this change. The supply and demand adjusting system according to this embodiment allows the consumer (supply and demand mediating terminal 104) to change the contents of the reply at least in a direction for decreasing an energy reduction amount. Thus, excessive energy reduction exceeding the target value is unlikely to occur.

In the supply and demand adjusting system according to the embodiment of the present invention, the supply and demand mediating device 102 adopts a consumer qualified to receive an incentive based on the requested reduction amount received from the supply and demand adjusting device 101 and a reply from the supply and demand mediating terminal 104. The supply and demand mediating device 102 notifies the supply and demand mediating terminal 104 belonging to the consumer qualified to receive the incentive of a final value of the incentive unit price and an energy reduction amount (As_{(y)}) required for the consumer to receive the incentive based on the incentive unit price.

In the supply and demand adjusting system according to the embodiment of the present invention, after the consumer is adopted, the supply and demand adjusting device 101 notifies the supply and demand mediating device 102 of a final value of the requested reduction amount (specifically, the reduction reference value Ac). The final value of the requested reduction amount is equal to or less than the requested reduction amount at the time of adoption of the consumer. Based on the final value of the requested reduction amount received from the supply and demand adjusting device 101, the supply and demand mediating device 102 notifies the supply and demand mediating terminal 104 belonging to the consumer qualified to receive the incentive of a final value of an energy reduction amount (specifically, Ag1_{(y)} and Ag2_{(y)}) required to receive the incentive based on the incentive unit price.

Thus, the consumer is allowed to ensure the incentive corresponding to As_{(y)} with the energy reduction amount Ag_{(y)} not exceeding the energy reduction amount As_{(y)} notified from the supply and demand mediating device 102 when the consumer is adopted. Further, a utility company controls energy reduction to a minimum required level. Thus, the utility company is allowed to minimize drop in income from energy usage charge paid by the consumer.

The supply and demand adjusting system according to the embodiment of the present invention further includes the at least one supply and demand mediating terminal 104.

In the supply and demand adjusting system according to this embodiment, the consumer (supply and demand mediating terminal 104) is allowed to change the contents of a reply at least in a direction for decreasing an energy reduction amount. This moderates limitation on the consumer. Thus, the supply and demand adjusting system according to this embodiment is a system that allows a consumer to change a reducible energy amount easily.

The energy supply and demand adjusting method according to the embodiment of the present invention is implemented by the supply and demand adjusting device 101 that works cooperatively with the supply and demand mediating device 102 to adjust energy supply and demand. The supply and demand adjusting device 101 and the supply and demand mediating device 102 are connected in a manner that allows bidirectional communication therebetween. The supply and demand mediating device 102 is connected to the supply and demand mediating terminal 104 provided to a consumer in a manner that allows bidirectional communication therebetween. The energy supply and demand adjusting method includes: a step (a) in which the supply and demand adjusting device 101 sets a requested reduction amount of energy at date and time when energy usage is scheduled to be reduced to be larger than a target value, and notifies the supply and demand mediating device 102 of the requested reduction amount and the scheduled date and time together; a step (b) in which the supply and demand adjusting device 101 receives a total amount of reducible energy from the supply and demand mediating device 102 as a reply to the notification in the step (a); and a step (c) executed after the step (b) and in which the supply and demand adjusting device 101 inquires of the supply and demand mediating device 102 about a total amount of reducible energy reducible by the consumer at the time of the inquiry as the scheduled date and time approaches, receives a reply to the inquiry from the supply and demand mediating device 102, decreases the requested reduction amount stepwise so as to make the requested reduction amount approach the target value, notifies the supply and demand mediating device 102 of a resultant requested reduction amount each time the requested reduction amount is decreased, and receives a reply to the notification from the supply and demand mediating device 102.

In the energy supply and demand adjusting method according to the embodiment of the present invention, in the step (a), the supply and demand adjusting device 101 sets a requested reduction amount of energy to be larger than a target value, and notifies the supply and demand mediating device 102 of the requested reduction amount. Then, in the step (c), the supply and demand adjusting device 101 decreases the requested reduction amount of energy further within an allowable range so as to coincide with timing earlier than the date and time when energy is scheduled to be reduced (a day of execution of energy reduction) by a predetermined period and to coincide with timing closer to the day of execution of energy reduction, and notifies the supply and demand mediating device 102 of the resultant requested reduction amount. In this way, the requested reduction amount of energy is initially set to be larger than the target value. As the day of execution of energy reduction approaches, the requested reduction amount is decreased stepwise. This makes it possible to reduce the likelihood of shortage of an energy reduction amount on the day of execution of energy reduction. Further, the amount of energy to be actually reduced is allowed to match the target value with a high degree of precision, so that excessive energy reduction exceeding the target value is unlikely to occur. Preventing energy reduction exceeding the target value makes it possible to cut redundant incentive cost.

As the day of execution of energy reduction approaches, the supply and demand adjusting device 101 decreases the requested reduction amount of energy stepwise. Thus, a change in a reducible energy amount made by the consumer is allowable, even if this change is made during making of a reduction plan. The consumer is allowed to change a reducible energy amount even when the supply and demand adjusting device 101 collects energy reduction. This moderates limitation on the consumer to allow the consumer to change a reducible energy amount more easily.

The step (c) in the energy supply and demand adjusting method according to the embodiment of the present invention further includes the step of changing the target value to a more precise target value as the scheduled date and time approaches.

By resetting the target value to a new value, a resultant requested reduction amount of energy can be a more proper and more precise amount than the target value initially set.

In the steps (a) and (c) in the energy supply and demand adjusting method according to the embodiment of the present invention, the supply and demand adjusting device 101 notifies the supply and demand mediating device 102 of a condition for an incentive to be given to the consumer when the supply and demand mediating device 102 is notified of the requested reduction amount. The method further includes: a step (d) in which the supply and demand adjusting device 101 changes the condition for the incentive in a manner that depends on a relationship between the total amount of reducible energy and the requested reduction amount.

The energy supply and demand adjusting method according to the embodiment of the present invention further includes: a step (e) in which the supply and demand mediating device 102 determines an incentive unit price corresponding to the scheduled date and time within a range of the condition for the incentive if the supply and demand mediating device 102 receives the requested reduction amount of energy, the scheduled date and time, and the condition for the incentive from the supply and demand adjusting device 101, and notifies the supply and demand mediating terminal 104 of the scheduled date and time and the incentive unit price; a step (f) in which the supply and demand mediating device 102 receives a reply to the notification from the supply and demand mediating terminal 104; and a step (g) in which the supply and demand mediating device 102 notifies the supply and demand mediating terminal 104 of stop of energy reduction request if a total energy reduction amount collected in the reply from the supply and demand mediating terminal 104 reaches the requested reduction amount. Even after the reply is received from the supply and demand mediating terminal 104 in the step (f), the supply and demand mediating device 102 accepts change in contents of the reply at least in a direction for decreasing an energy reduction amount.

For example, the supply and demand adjusting sequence is started with a relatively low incentive unit price. If the total amount of reducible energy does not reach the requested reduction amount while the day of execution of energy reduction approaches, the incentive unit price is changed in a direction for increasing the incentive unit price. By doing so, the total amount of reducible energy is allowed to match the requested reduction amount precisely with a proper incentive unit price.

The energy supply and demand adjusting method according to the embodiment of the present invention further includes: a step (h) in which the supply and demand mediating device 102 adopts a consumer qualified to receive an incentive in response to each date and time when energy is scheduled to be reduced and based on the requested reduction amount received from the supply and demand adjusting device 101 and a reply from the supply and demand mediating terminal 104. In the step (h), the supply and demand mediating device 102 notifies the supply and demand mediating terminal 104 belonging to the consumer qualified to receive the incentive of a final value of the incentive unit price and an energy reduction amount required for the consumer to receive the incentive based on the incentive unit price.

The energy supply and demand adjusting method according to the embodiment of the present invention further includes: a step (i) in which, after the consumer is adopted in the step (h), the supply and demand adjusting device 101 notifies the supply and demand mediating device 102 of a final value of the requested reduction amount; and a step (j) in which, based on the final value of the requested reduction amount received from the supply and demand adjusting device 101, the supply and demand mediating device 102 notifies the supply and demand mediating terminal 104 belonging to the consumer qualified to receive the incentive of a final value of an energy reduction amount required to receive the incentive based on the incentive unit price. The final value of the requested reduction amount is equal to or less than the requested reduction amount at the time of adoption of the consumer.

Thus, the consumer is allowed to ensure the incentive corresponding to As_{(y)} with the energy reduction amount Ag_{(y)} not exceeding the energy reduction amount As_{(y)} notified from the supply and demand mediating device 102 when the consumer is adopted in the step (h). Further, the utility company controls energy reduction to a minimum required level. Thus, the utility company is allowed to minimize drop in income from energy usage charge paid by the consumer.

While the invention has been shown and described in detail, the foregoing description is in all aspects illustrative and does not restrict the invention. It is therefore understood that numerous modifications not illustrated can be devised without departing from the scope of the invention.

### EXPLANATION OF REFERENCE SIGNS

100 Supply and demand adjusting system

101 Supply and demand adjusting device

102 Supply and demand mediating device

103 Information database

104 Supply and demand mediating terminal

105 Watt-hour meter

106 Communication network

11, 21 CPU

12, 22 Memory

13, 23 Input/output interface

14, 24 Network interface

15, 25 Storage

16, 26 Bus

1: A supply and demand adjusting device that works cooperatively with a supply and demand mediating device to adjust energy supply and demand, wherein
the supply and demand adjusting device and the supply and demand mediating device are connected in a manner that allows bidirectional communication therebetween,
the supply and demand mediating device is connected to a supply and demand mediating terminal provided to a consumer in a manner that allows bidirectional communication therebetween,
the supply and demand adjusting device sets a requested reduction amount of energy at date and time when energy usage is scheduled to be reduced to be larger than a target value, and notifies the supply and demand mediating device of the requested reduction amount and the scheduled date and time together,
the supply and demand adjusting device receives a total amount of reducible energy reducible by the consumer from the supply and demand mediating device as a reply to the notification,
as the scheduled date and time approaches, the supply and demand adjusting device inquires of the supply and demand mediating device about a total amount of reducible energy reducible by the consumer at the time of the inquiry, receives a reply to the inquiry from the supply and demand mediating device, decreases the requested reduction amount stepwise so as to make the requested reduction amount approach the target value, notifies the supply and demand mediating device of a resultant requested reduction amount each time the requested reduction amount is decreased, and receives a reply to the notification from the supply and demand mediating device.

2: The supply and demand adjusting device according to claim 1, wherein
as the scheduled date and time approaches, the target value is changed to a more precise target value.

3: The supply and demand adjusting device according to claim 1, wherein
the supply and demand adjusting device notifies the supply and demand mediating device of a condition for an incentive to be given to the consumer when the supply and demand mediating device is notified of the requested reduction amount, and
the supply and demand adjusting device changes the condition for the incentive in a manner that depends on a relationship between the total amount of reducible energy and the requested reduction amount.

4: A supply and demand adjusting system comprising:
the supply and demand adjusting device according to claim 1; and
a supply and demand mediating device that works cooperatively with the supply and demand adjusting device to adjust energy supply and demand, wherein
if the supply and demand mediating device receives the requested reduction amount, the scheduled date and time, and a condition for an incentive to be given to the consumer from the supply and demand adjusting device, the supply and demand mediating device determines an incentive unit price corresponding to the scheduled date and time within a range of the condition for the incentive, and notifies the supply and demand mediating terminal of the scheduled date and time and the incentive unit price,
the supply and demand mediating device receives a reply to the notification from the supply and demand mediating terminal,
even after the reply is received from the supply and demand mediating terminal, the supply and demand mediating device accepts change in contents of the reply at least in a direction for decreasing an energy reduction amount, and
if a total energy reduction amount collected in the reply from the supply and demand mediating terminal reaches the requested reduction amount, the supply and demand mediating device notifies the supply and demand mediating terminal of stop of energy reduction request.

5: The supply and demand adjusting system according to claim 4, wherein
the supply and demand mediating device adopts a consumer qualified to receive an incentive in response to the scheduled date and time and based on the requested reduction amount received from the supply and demand adjusting device and a reply from the supply and demand mediating terminal, and
the supply and demand mediating device notifies the supply and demand mediating terminal belonging to the consumer qualified to receive the incentive of a final value of the incentive unit price and an energy reduction amount required for the consumer to receive the incentive based on the incentive unit price.

6: The supply and demand adjusting system according to claim 5, wherein
after the consumer is adopted, the supply and demand adjusting device notifies the supply and demand mediating device of a final value of the requested reduction amount in response to the scheduled date and time,
the final value of the requested reduction amount is equal to or less than the requested reduction amount at the time of adoption of the consumer, and
based on the final value of the requested reduction amount received from the supply and demand adjusting device, the supply and demand mediating device notifies the supply and demand mediating terminal belonging to the consumer qualified to receive the incentive of a final value of an energy reduction amount required to receive the incentive based on the incentive unit price.

7: The supply and demand adjusting system according to claim 4, further comprising the at least one supply and demand mediating terminal.

8: An energy supply and demand adjusting method implemented by a supply and demand adjusting device that works cooperatively with a supply and demand mediating device to adjust energy supply and demand,
the supply and demand adjusting device and the supply and demand mediating device being connected in a manner that allows bidirectional communication therebetween,
the supply and demand mediating device being connected to a supply and demand mediating terminal provided to a consumer in a manner that allows bidirectional communication therebetween,
the method comprising:
(a) a step in which the supply and demand adjusting device sets a requested reduction amount of energy at date and time when energy usage is scheduled to be reduced to be larger than a target value, and notifies the supply and demand mediating device of the requested reduction amount and the scheduled date and time together;
(b) a step in which the supply and demand adjusting device receives a total amount of reducible energy from the supply and demand mediating device as a reply to the notification in the step (a); and
(c) a step executed after the step (b) and in which the supply and demand adjusting device inquires of the supply and demand mediating device about a total amount of reducible energy reducible by the consumer at the time of the inquiry as the scheduled date and time approaches, receives a reply to the inquiry from the supply and demand mediating device, decreases the requested reduction amount stepwise so as to make the requested reduction amount approach the target value, notifies the supply and demand mediating device of a resultant requested reduction amount each time the requested reduction amount is decreased, and receives a reply to the notification from the supply and demand mediating device.

9: The energy supply and demand adjusting method according to claim 8, wherein
the step (c) further includes a step of changing the target value to a more precise target value as the scheduled date and time approaches.

10: The energy supply and demand adjusting method according to claim 8, wherein
in the steps (a) and (c), the supply and demand adjusting device notifies the supply and demand mediating device of a condition for an incentive to be given to the consumer when the supply and demand mediating device is notified of the requested reduction amount,
the method further comprising:
(d) a step in which the supply and demand adjusting device changes the condition for the incentive in a manner that depends on a relationship between the total amount of reducible energy and the requested reduction amount.

11: The energy supply and demand adjusting method according to claim 8, further comprising:
(e) a step in which, if the supply and demand mediating device receives the requested reduction amount, the scheduled date and time, and a condition for an incentive to be given to the consumer from the supply and demand adjusting device, the supply and demand mediating device determines an incentive unit price corresponding to the scheduled date and time within a range of the condition for the incentive, and notifies the supply and demand mediating terminal of the scheduled date and time and the incentive unit price;
(f) a step in which the supply and demand mediating device receives a reply to the notification from the supply and demand mediating terminal; and
(g) a step in which the supply and demand mediating device notifies the supply and demand mediating terminal of stop of energy reduction request if a total energy reduction amount collected in the reply from the supply and demand mediating terminal reaches the requested reduction amount, wherein
even after the reply is received from the supply and demand mediating terminal in the step (f), the supply and demand mediating device accepts change in contents of the reply at least in a direction for decreasing an energy reduction amount.

12: The energy supply and demand adjusting method according to claim 11, further comprising:
(h) a step in which the supply and demand mediating device adopts a consumer qualified to receive an incentive in response to the scheduled date and time and based on the requested reduction amount received from the supply and demand adjusting device and a reply from the supply and demand mediating terminal, wherein
in the step (h), the supply and demand mediating device notifies the supply and demand mediating terminal belonging to the consumer qualified to receive the incentive of a final value of the incentive unit price and an energy reduction amount required for the consumer to receive the incentive based on the incentive unit price.

13: The energy supply and demand adjusting method according to claim 12, further comprising:
(i) a step in which, after the consumer is adopted in the step (h), the supply and demand adjusting device notifies the supply and demand mediating device of a final value of the requested reduction amount in response to the scheduled date and time; and
(j) a step which, based on the final value of the requested reduction amount received from the supply and demand adjusting device, the supply and demand mediating device notifies the supply and demand mediating terminal belonging to the consumer qualified to receive the incentive of a final value of an energy reduction amount required to receive the incentive based on the incentive unit price, wherein
the final value of the requested reduction amount is equal to or less than the requested reduction amount at the time of adoption of the consumer.
